(19) United States
(12) Patent Application Publication
(10) Pub. No.: US 2016/0011654 A1
(43) Pub. Date: Jan. 14, 2016

(54) INTERFACING APPARATUS AND USER INPUT PROCESSING METHOD

(71) Applicant: SAMSUNG ELECTRONICS CO., LTD., Suwon-si (KR)

(72) Inventors: Jun Haeng LEE, Hwaseong-si (KR); Jun Seok KIM, Hwaseong-si (KR); Chang Woo SHIN, Hwaseong-si (KR); Eric Hyun-surk RYU, Hwaseong-si (KR)

(73) Assignee: SAMSUNG ELECTRONICS CO., LTD., Suwon-si (KR)

(21) Appl. No.: 14/677,084

(22) Filed: Apr. 2, 2015

(30) Foreign Application Priority Data
Jul. 14, 2014 (KR) 10-2014-0088553
Aug. 4, 2014 (KR) 10-2014-0099937

(51) Int. Cl. G06F 3/01; G06F 3/00; G06F 3/16

(52) U.S. Cl. CPC G06F 3/01; G06F 3/167; G06F 3/005; G06F 2203/0382

(57) ABSTRACT

An interfacing apparatus and a user input processing method are provided. The interfacing apparatus may group event generation elements and output an address of a group in which an event occurs based on a generated group event signal. The interfacing apparatus may include a grouper configured to generate a group event signal in which a plurality of event generation elements corresponding to a plurality of pixels in at least one event sensor are grouped based on one or more events occurring with respect to the plurality of pixels, and an interface configured to output an address of the group of the plurality of event generation elements in which the one or more event occurs based on the generated group event signal

### CROSS-REFERENCE TO RELATED APPLICATIONS

This application claims priority from Korean Patent Application No. 10-2014-0088553 filed on Jul. 14, 2014, and Korean Patent Application No. 10-2014-0099937 filed on Aug. 4, 2014, in the Korean Intellectual Property Office, the disclosures of which are incorporated herein by reference in their entirety.

### BACKGROUND

1. Field

Apparatuses and methods consistent with exemplary embodiments relate to an interfacing apparatus and a user input processing method, and more specifically, to apparatuses and methods that are capable of processing video and audio event sensors more efficiently.

2. Description of Related Art

Human-computer interaction (HCI) technology refers to a technology that increases an interaction between a user and a computer. A user input may be transmitted to a computer using various user interfaces, for example, to input data, a user may use a mouse, a keyboard, a touchscreen, and the like. Such a user interface may be implemented using a hardware component, a software component, and/or a combination thereof.

Because a camera, a microphone, and other components are widely utilized in electronic devices, a user interface (UI) may be used to increase an interaction between a user and a computer. Thus, various functions of the electronic devices may be more efficiently utilized.

In a related art, an interface acquires data from display and audio event sensors on a one by one basis. That is, information from one sensor is acquired individually in time. The result is that a processing delay and a loss of information that occurs when multiple audio event items or multiple video events are generated simultaneously. As a result, the related art interface is not well equipped for higher-resolution interfaces such as that in a quarter video graphics array (QVGA) which may be used for smaller handheld devices which typically require higher efficient data and audio processing within a smaller display.

### SUMMARY

One or more exemplary embodiments may address at least the above problems and/or disadvantages and other disadvantages not described above. Also, an exemplary embodiment is not required to overcome the disadvantages described above, and an exemplary embodiment may not overcome any of the problems described above.

According to one or more exemplary embodiments, there is provided an interface that may simultaneously acquire events from a plurality of event sensors, thereby processing information at a faster rate in comparison to the related art interface which processes information from event sensors one at a time. As a non-limiting example, the event-based driven technology may be applicable to large-capacity neuromorphic chips.

According to an aspect of an exemplary embodiment, there is provided an interfacing apparatus including a grouper configured to generate a group event signal in which a plurality of event generation elements corresponding to a plurality of pixels in at least one event sensor are grouped based on one or more events occurring with respect to the plurality of pixels, and an interface configured to output an address of the group of the plurality of event generation elements in which the one or more event occurs based on the generated group event signal.

The event generation elements may be respectively configured to generate an event signal asynchronously in response to an occurrence of an event corresponding to a respective event generation element.

The address of the group may be an address representing the plurality of event generation elements belonging to the group.

The plurality of event generation elements of the group may be disposed consecutively in a predetermined pattern.

The predetermined pattern may include at least one of a pattern in which event generation elements are disposed consecutively in a row direction in a group, a pattern in which event generation elements are disposed consecutively in a column direction in a group, and a pattern in which event generation elements are disposed in a form of a matrix in both the row direction and the column direction of a group.

The interface may output an address corresponding to the group event signal, in response to the generated group event signal.

The interface may select one of a plurality of generated group event signals and output an address corresponding to the selected group event signal.

The interface may further output data of the group of the plurality of elements based on the group event signal.

The interface may further output a timestamp that corresponds to a time at which the event occurs, in response to the group event signal.

Each of the event generation elements may include at least one of a first state corresponding to an occurrence of an event, and a second state distinct from the first state.

The event generation elements may be initialized in the second state, transition to the first state in response to the occurrence of the event, and transition to the second state in response to a reset signal.

The event generation elements may be respectively configured to generate an event signal in the first state.

The interface may include a first arbiter configured to select one from at least one first group event signal in response to the at least one first group event signal, and a second arbiter configured to select one from at least one second group event signal in response to the at least one second group event signal corresponding to the selected first group event signal.

The at least one first group event signal may be generated by grouping first event signals corresponding to the event generation elements, and the at least one second group event signal may be generated by grouping second event signals corresponding to the event generation elements.

The first event signals may be event signals that are output from the event generation elements in a first direction, and the second event signals may be event signals that are output from the event generation elements in a second direction.

The first arbiter may output a first address corresponding to the selected first group event signal, the second arbiter may output a second address corresponding to the selected second group event signal, and the interface may further include a data output unit configured to output data of a group corresponding to the first address and the second address.

The interface may further include a communicator configured to transmit a request signal to control an output of the first address, the second address, and the data, and receive a response signal that is configured to control a read-out of the first address, the second address, and the data.

The second arbiter may apply a reset signal to event generation elements corresponding to the second address, in response to the response signal.

The interface may include a first arbiter configured to select one group event signal from at least one first group event signal, in response to the at least one first group event signal, and a second arbiter configured to iteratively select at least two second group event signals from a plurality of second group event signals, in response to the plurality of second group event signals corresponding to the selected first group event signal.

The first arbiter may be configured to output a first address corresponding to the selected first group event signal, and the second arbiter may be configured to iteratively output second addresses corresponding to the at least two selected plurality of second group event signals.

The interface may further include a data output unit configured to output data of a group corresponding to the first address and a currently output second address corresponding to a current second group of event signals among the second addresses corresponding to the at least two of the plurality of second group event signals.

The second arbiter may be configured to apply a reset signal to event generation elements corresponding to the second addresses after the second addresses are output.

The interfacing apparatus may further include at least one of a vision sensor comprising the event generation elements, an auditory sensor comprising the event generation elements, and a processing device comprising the event generation elements.

According to an aspect of another exemplary embodiment, there is provided a user input processing method including receiving an address of a group of event generation elements in which an event occurs and data of the group, in response to a user input, obtaining event information based on the received address of the group, the data of the group, and grouping information of the group, and processing the user input based on the obtained event information.

The group of event generation elements may be disposed consecutively in a predetermined pattern, and the event generation elements may be respectively configured to generate an event signal asynchronously in response to an occurrence of an event.

The address of the group may include an address representing event generation elements belonging to the group.

The receiving may include receiving a request signal, reading out a first address of the group, reading out a second address of the group, reading out data of the group, and transmitting a response signal.

The receiving may include receiving a first address common to a plurality of groups, and iteratively receiving items of data of the plurality of groups and second addresses that distinguish the plurality of groups.

The receiving of the first address may include receiving a first request signal, reading out the first address, and transmitting a first response signal.

The iteratively receiving items of data of the plurality of groups and second addresses may include receiving a second request signal, reading out a currently received second address from among the second addresses, reading out currently received data from among the items of data, and transmitting a second response signal based on both of the readings.

The grouping information may include dimension information of the group, and information on mapping between a plurality of bits of the data of the group and event generation elements in the group.

The obtaining may include calculating reference coordinates corresponding to the address of the group, and calculating coordinates of at least one pixel in which an event occurs based on the reference coordinates, the data of the group, and the grouping information of the group.

According to an aspect of another exemplary embodiment there is provided a non-transitory computer-readable medium having recorded thereon a computer program that is executable by a computer to perform the method according to one or more exemplary embodiments.

According to an aspect of another exemplary embodiment, there is provided a processing apparatus configured to increase a processing rate of a display apparatus, the processing apparatus including an interface configured to receive a group of events that occur in the display apparatus, the group of events corresponding to a plurality of event-based elements of the display apparatus which detect one or more events, and a processor configured to simultaneously process the group of events corresponding to the plurality of event-based elements, during a same clock cycle.

The processing apparatus may further include a grouper configured to generate the group of events by grouping event-based elements of the display apparatus into a plurality of groups, wherein the group of events is selected from among the plurality of groups.

The group of events may be generated by a group of video event-based elements, and the interface may be configured to receive, and the processor may be configured to simultaneously process, the group of events generated by the plurality of video event-based elements.

The group of events may be generated by a group of audio event-based elements, and the interface may be configured to receive, and the processor may be configured to simultaneously process, the group of events generated by the plurality of audio event-based elements.

The group of events may correspond to a two-dimensional shape of event-based elements of the display apparatus which detect the one or more events.

At least one event-based element corresponding to the plurality of event-based elements of the display apparatus which detect the one or more events may include an event-based element which does not detect an occurrence of an event.

The processor may be configured to simultaneously process the group of events corresponding to the plurality of event-based elements, during a same clock cycle.

### BRIEF DESCRIPTION OF THE DRAWINGS

The above and other aspects of the exemplary embodiments will become more apparent by describing certain exemplary embodiments with reference to the accompanying drawings, in which:

FIGS. 1, 2, 3A through 3E and 4A through 4F illustrate diagrams an interfacing apparatus according to exemplary embodiments;

FIG. 5A through 5C illustrate operations of an interfacing apparatus according to exemplary embodiments;

FIGS. 6A through 6D illustrate operations of an interfacing apparatus according to other exemplary embodiments;

FIGS. 7A and 7B illustrate operations of an interfacing apparatus according to other exemplary embodiments;

FIGS. 8A through 8D illustrate examples of obtaining data of a group according to exemplary embodiments;

FIG. 9 illustrates an operation of an interfacing apparatus communicating with an external device according to an exemplary embodiment;

FIGS. 10A through 10D, 11A, 11B and 12 illustrate examples of various packets used by an interfacing apparatus according to exemplary embodiments;

FIGS. 13 and 14 illustrate operations of an interfacing apparatus according to other exemplary embodiments;

FIG. 15 illustrates information applied to an address bus and a data bus that may change over time; and

FIG. 16 illustrates a user input processing method according to an exemplary embodiment.

FIG. 17 is a diagram illustrating an address bus and a data bus, such as that shown in the example of FIG. 10A, that are used to identify a group of elements in which an event occurs, according to an exemplary embodiment.

### DETAILED DESCRIPTION

Reference will now be made in detail to exemplary embodiments, examples of which are illustrated in the accompanying drawings, wherein like reference numerals refer to like elements throughout. The exemplary embodiments are described below in order to explain the present disclosure by referring to the figures.

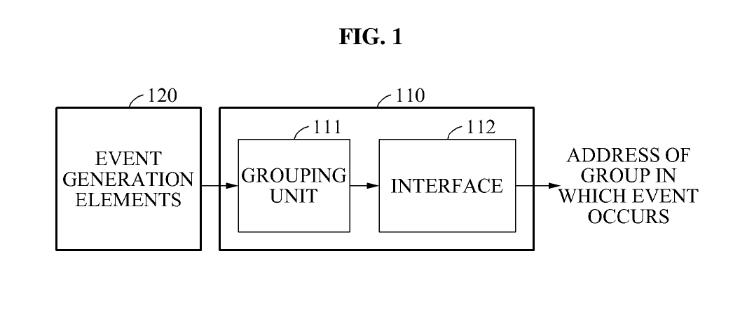

FIGS. 1 through 4F illustrate an interfacing apparatus 110 according to exemplary embodiments.

Referring to FIG. 1, the interfacing apparatus 110 receives signals that are output from event generation elements 120. The event generation elements 120 refer to elements that output event signals that may be based on a sensed video or audio event that occurs. As an example, the event generation elements 120 may generate an event signal asynchronously in response to an occurrence of an event. Hereinafter, an event generation element may also be more simply referred to as an element.

For example, the various products using the event-based sensors may be included in or otherwise be applicable to smart phones, smart home appliances, wearable devices, desktop computers, laptop computers, tablet computers, kiosks, and the like, which may perform one or more of motion recognition, face recognition, voice recognition, user authentication, and the like, using an event-based vision sensor, an event-based auditory sensor, an event-based processing device, and the like.

As a non-limiting example, the event generation elements 120 may be implemented using event-based vision sensors. An event-based vision sensor may output an event signal, for example, that is time-asynchronously in response to the sensing of a light changing event. For example, the event-based vision sensor may sense a brightness of light increasing event or a brightness of light decreasing event. As another example, the event-based vision sensor may sense a color of a light changing event. A frame based vision sensor may scan an output of a photodiode of each pixel in a plurality of frame units such as dynamic-vision-sensor (DVS) pixels, whereas the event-based vision sensor may output an event signal of a pixel in which a change of light is sensed.

As another example, the event generation elements 120 may be implemented using event-based auditory sensors. An event-based auditory sensor may output an event signal time-asynchronously in response to sensing a sound or audio changing event. For example, the event-based auditory sensor may sense an amplitude of a sound increasing event or an amplitude of a sound decreasing event. As another example, the event-based auditory sensor may sense a frequency of a sound increasing event or a frequency of a sound decreasing event.

In some embodiments, a sensor for sensing audio events such as a change in volume and a sensor for sensing video events such as a change in the display may different from each other. According to various aspects, the grouping unit 111 may group just audio events together, video events together, and the like, such that only the respective type of events are processed simultaneously.

According to one or more exemplary embodiments, the grouping unit 111 or otherwise referred to as a grouper as shown in FIG. 1, is not included in the related art and groups sensor event elements into groups instead of a single sensor event element. For example, the size, shape, and pattern of the groups of sensor elements can be predetermined. In some examples, the grouping unit 111 may be designed according to the predetermined size and pattern of the groups.

The event generation elements 120 may be implemented using event-based processing devices. As an example, an event-based processing device may be more simply referred to as a processor. The event-based processing device may output a spike signal, for example, automatically or in response to receiving at least one input. The event-based processing device may perform signal processing and recognition, in response to an input of a sensor signal or an output signal of another neuron using a network that is configured by at least one neuron.

It should be appreciated that the implementation of the event generation elements 120 are provided for purposes of example and are not meant to be limited thereto. The event generation elements 120 may be modified in various forms to generate event signals time-asynchronously in response to the sensing of a predetermined event.

The event generation elements 120 may continuously output event signals, for example, until being reset. The event generation elements 120 may generate event signals time-asynchronously in response to the sensing of a predetermined event, and continuously output the generated event signals. As an example, the event generation elements 120 may be reset when a reset signal is received from an external device. In response, the event generation elements 120 may suspend outputting of the event signals in response to being reset.

The operations of the event generation elements 120 may be described based on a state transition. For example, the event generation element 120 may be in one of a first state corresponding to an occurrence of an event, and a second state distinct from the first state. The event generation element 120 may generate an event signal in the first state. In some examples, the event generation element 120 may be initialized to be in the second state, and transition to the first state in response to an occurrence of an event. For example, the event generation element 120 may transition to the second state in response to a reset signal.

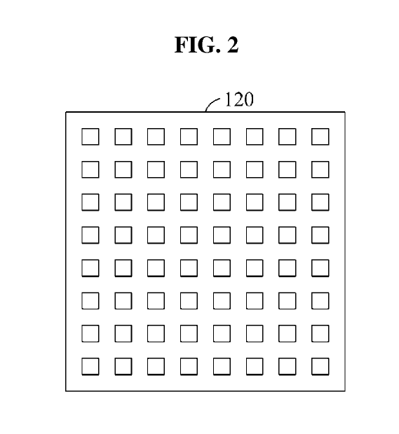

In the example of FIG. 1, according to one or more exemplary embodiments of the present application, the interfacing apparatus 110 includes a grouping unit 111, which may also be referred to as a grouper 111. The interfacing apparatus 100 also includes an interface 112. The grouping unit 111 may generate a group event signal in which a plurality of event generation elements 120 are grouped rather than generating a group event signal such as the relate art in which only a single event generation element is identified. According to one or more exemplary embodiments, the event generation elements 120 may be disposed in the form of a matrix such as a square, a rectangle, a successive line of elements, and the like, but the sizes, patterns, and shapes, are unlimited and do not have to fit within a specific shape. That is, the event generation elements 120 may be grouped in various forms. For example, in FIG. 2, event generation elements are disposed consecutively in a predetermined pattern such as a column or a row may be grouped into the same group.

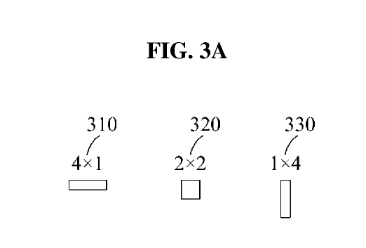

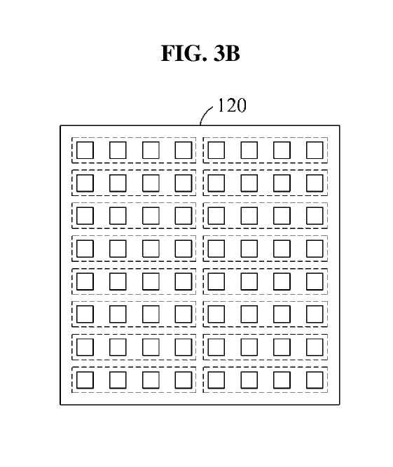

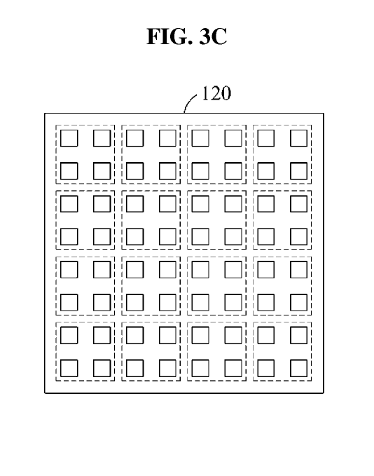

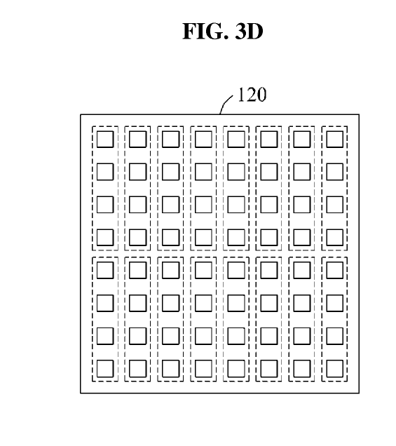

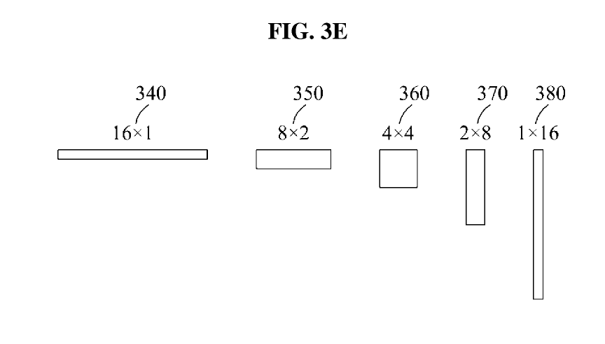

As a non-limiting example, the event generation elements 120 may be grouped in units of two, elements, three elements, four elements, more elements, or less elements. Referring to FIG. 3A, event generation elements may be grouped in various forms such as a 4×1 successive horizontal line form 310, a 2×2 square form 320, and a 1×4 successive vertical line form 330. Referring to FIG. 3B, the event generation elements 120 are grouped in a plurality of successive horizontal lines in a 4×1 form. Referring to FIG. 3C, the event generation elements 120 are grouped in a plurality of squares of a 2×2 form. Referring to FIG. 3D, the event generation elements 120 are grouped in a plurality of successive vertical lines 1×4 form.

As another non-limiting example, the event generation elements 120 may be grouped in different size units such as groups of 4 elements, 8 elements, sixteen elements, and the like. In some examples, the size and the pattern of the groups may be predetermined. Also, in some examples, the grouping unit 111 may be determined according to a size and pattern of the groups. Referring to FIG. 3E, event generation elements may be grouped in a 16×1 form 340, an 8×2 form 350, a 4×4 form 360, a 2×8 form 370, and a 1×16 form 380. The descriptions of the forms in which the event generation elements are grouped are provided exemplarily. It should also be appreciated that the forms in which the event generation elements are grouped may be variously modified. It should also be appreciated that the size of the groups are not limited to 4 elements, 8 elements, sixteen elements, or the like, and may be grouped in any non-limiting example.

Referring again to FIG. 1, the grouping unit 111 may generate the group event signal in which the event generation elements 120 are grouped. When the event generation elements 120 are grouped, a plurality of groups may be formed. In this example, the grouping unit 111 may generate a group event signal corresponding to a group in which an event occurs, from among the plurality of groups. The group in which an event occurs refers to a group including at least one element where an event occurs, such as a visual event, an audio event, or a processing event. The element where the event occurs may generate an event signal in response to the sensing of an occurrence of an event. For example, an event-based vision sensor may sense a brightness of a light increasing event or a brightness of a light decreasing event. As another example, the event-based vision sensor may sense a color of a light changing event.

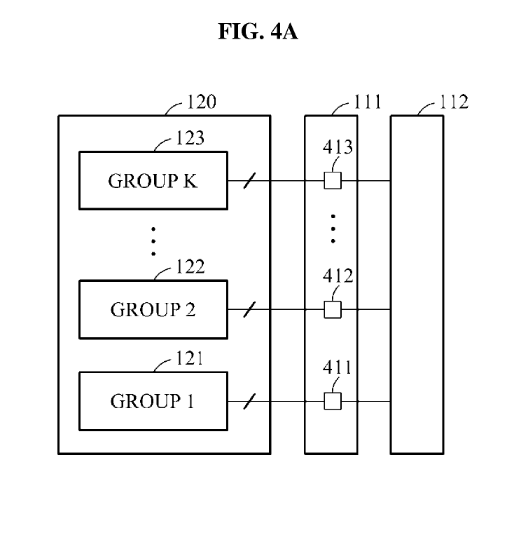

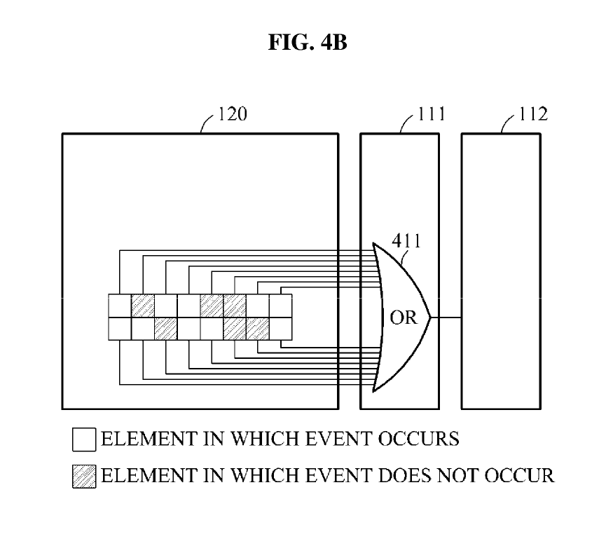

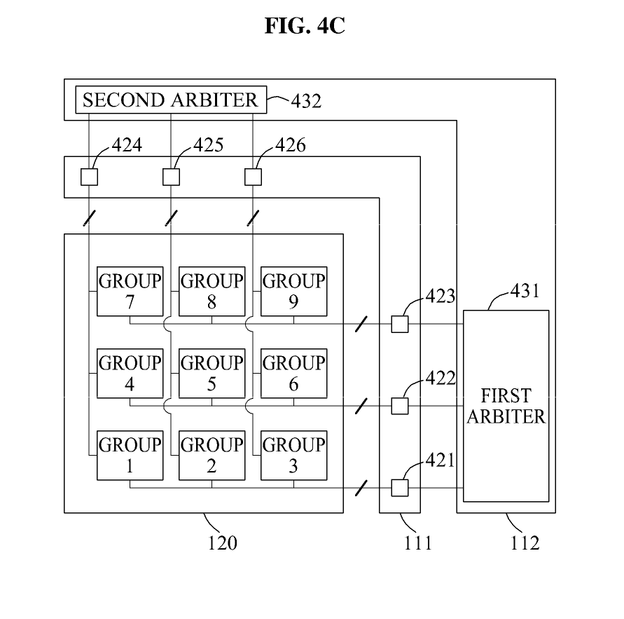

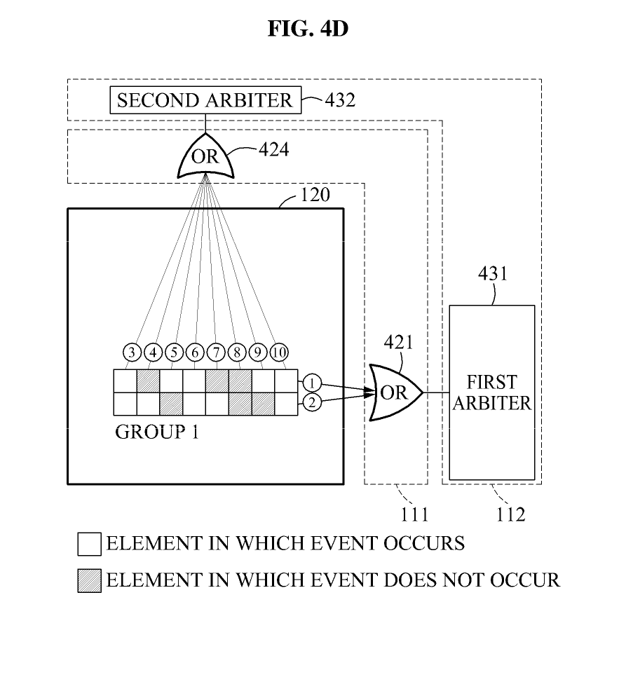

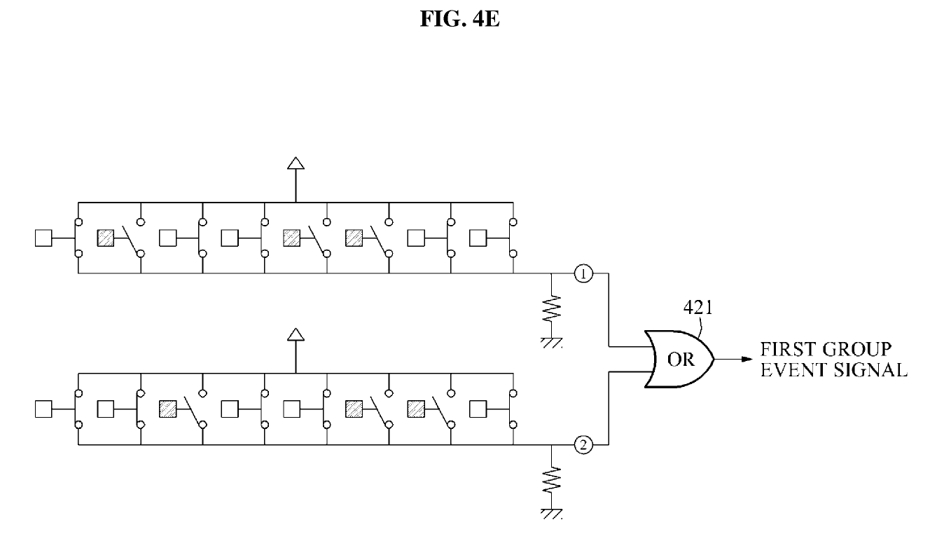

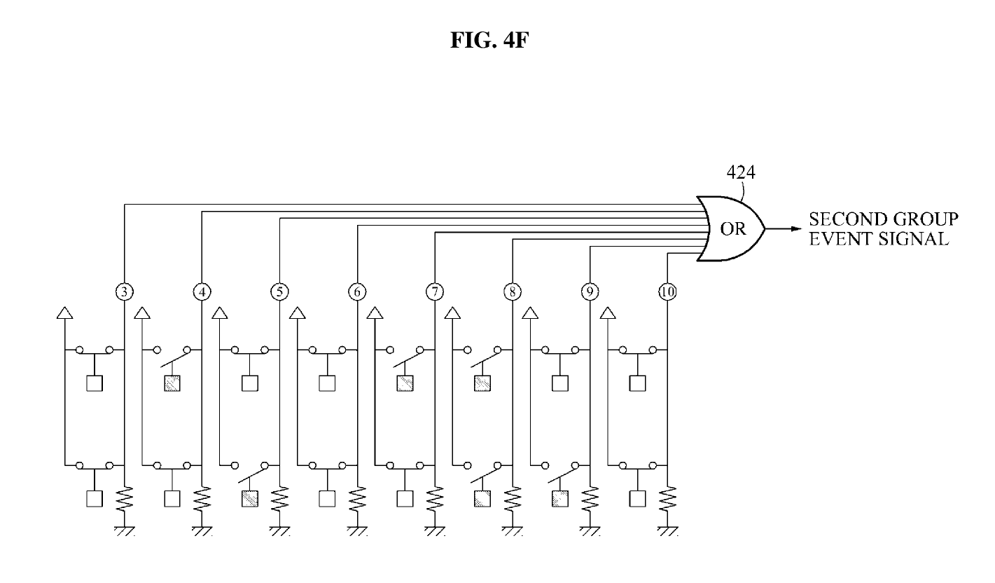

Referring to FIG. 4A, the event generation elements 120 are grouped in a first group 121, a second group 122, through a k-th group 123, respectively. In this example, the grouping unit 111 includes a first generator 411, a second generator 412, through a k-th generator 413. The first generator 411 may generate a group event signal when an event occurs in the first group 121. Likewise, the second generator 412 may generate a group event signal when an event occurs in the second group 122, and the k-th generator 413 may generate a group event signal when an event occurs in the k-th group 123.

The interface 112 may receive the group event signal that is generated by the grouping unit 111. The interface 112 may output an address of a group in which an event occurs based on the group event signal. For example, the address of the group may be an address representing event generation elements belonging to the group.

The interface 112 may output an address of a group in which an event occurs based on a generator from which a group event signal is received, from among the first generator 411 through the k-th generator 413. When a group event signal is received from the first generator 411, the interface 112 may output an address of the first group 121. When a group event signal is received from the k-th generator 413, the interface 112 may output an address of the k-th group 123.

As a non-limiting example, the first generator 411, the second generator 412, . . . , and the k-th generator 413 may be implemented using logic gates. Referring to FIG. 4B, the first generator 411 is an OR gate that is connected to elements of the first group 121. In this example, when an event signal is output from one of the elements of the first group 121, a group event signal may be generated by the first generator 411.

Referring to FIG. 4C, the grouping unit 111 is connected two-dimensionally to a plurality of groups. In this example, the grouping unit 111 includes a first generator 421, a second generator 422, a third generator 423, a fourth generator 424, a fifth generator 425, and a sixth generator 426.

In this example, the first generator 421 is connected to a first group, a second group, and a third group. When an event signal is output from any element of one of the first through third group, a group event signal may be generated by the first generator 421. The second generator 422 is connected to a fourth group, a fifth group, and a sixth group. When an event signal is output from an element of one of the fourth through the sixth groups, a group event signal may be generated by the second generator 422. Likewise, the third generator 423 is connected to a seventh group, an eighth group, and a ninth group. When an event signal is output from an element of one of the seventh through the ninth groups, a group event signal may be generated by the third generator 423.

From above, the fourth generator 424 is connected to the first group, the fourth group, and the seventh group. When an event signal is output from one element of any of the first group, the fourth group, or the seventh group, a group event signal may be generated by the fourth generator 424. The fifth generator 425 is connected to the second group, the fifth group, and the eighth group. When an event signal is output from one element of any of the second group, the fifth group, or the eighth group, a group event signal may be generated by the fifth generator 425. The sixth generator 426 is connected to the third group, the sixth group, and the ninth group. When an event signal is output from one element of any of the third group, the sixth group, or the ninth group, a group event signal may be generated by the sixth generator 426.

In this example, the interface 112 includes a first arbiter 431 and a second arbiter 432. The first arbiter 431 may receive the group event signals that are generated by one or more of the first generator 421, the second generator 422, and the third generator 423. Likewise, the second arbiter 432 may receive the group event signals that are generated by the fourth generator 424, the fifth generator 425, and the sixth generator 426. The first arbiter 431 may also be referred to as a line arbiter, and the second arbiter 432 may also be referred to as a group arbiter.

The first arbiter 431 may output a first address of a group in which an event occurs based on a generator from which a group event signal is received, from among the first generator 421, the second generator 422, and the third generator 423. In some examples, the first address may also be referred to as a line address. When a group event signal is received from the first generator 421, the first arbiter 431 may output an address indicating a row that is common to the first group, the second group, and the third group. Similarly, the first arbiter 431 may output an address indicating a row that is common to the fourth group, the fifth group, and the sixth group. When a group event signal is received from the third generator 423, the first arbiter 431 may output an address indicating a row that is common to the seventh group, the eighth group, the ninth group.

The second arbiter 432 may output a second address of a group in which an event occurs based on a generator from which a group event signal is received, from among the fourth generator 424, the fifth generator 425, and the sixth generator 426. In this example, the second address may be referred to as a group address. When a group event signal is received from the fourth generator 424, the second arbiter 432 may output an address indicating a column that is common to the first group, the fourth group, and the seventh group. Similarly, a group event signal may be received from the fifth generator 425, and the second arbiter 432 may output an address indicating a column that is common to the second group, the fifth group, and the eighth group. Also, a group event signal may be received from the sixth generator 426, and the second arbiter 432 may output an address indicating a column that is common to the third group, the sixth group, and the ninth group. One or more exemplary embodiments of operations of the first arbiter 431 and the second arbiter 432 are described further herein.

The first generator 421 through the sixth generator 426 may be implemented, for example, using logic gates. Referring to FIG. 4D, in this example, the first generator 421 is an OR gate that is connected to elements of the first group. In this example, the first group includes elements provided in a rectangular 8×2 form. Here, the first generator 421 is connected through a first row of the first group and a first line, and a second row of the first group and a second line. In this example, the fourth generator 424 is connected through a first column of the first group and what is represented by a third line, a second column of the first group and a fourth line, a third column of the first group and a fifth line, a fourth column of the first group and a sixth line, a fifth column of the first group and a seventh line, a sixth column of the first group and an eighth line, a seventh column of the first group and a ninth line, and an eighth column of the first group and a tenth line.

When an event signal is output from one of the elements included in the first row of the first group, for example, a signal corresponding to “TRUE” or “1” may be applied to the first line. Similarly when an event signal is output from any one of elements included in the second row of the first group, a signal corresponding to “TRUE” or “1” may be applied to the second line. As a non-limiting example, if a “TRUE” or “1” signal is applied to at least one of the first line and the second line, a group event signal may be generated by the first generator 421.

Referring to FIG. 4E, the first generator 421 is connected to the elements of the first row of the first group and the elements of the second row of the first group through circuits, for example, pull-down circuits, and the like. The elements may control their own respective switches. For example, an element in which an event occurs may turn a switch on, and an element in which an event does not occur may turn a switch off or keep or otherwise maintain a switch in the off state. Also, a plurality of switches may be connected to a single line.

When any one of the plurality of switches connected in the line is turned on, a supply voltage (VDD) may be applied to the line. In this example, a signal corresponding to “TRUE” or “1” may be applied to the line. Conversely, when all of the switches connected to the single line are turned off, a ground voltage (GND) may be applied to the line. In this example, a signal corresponding to “FALSE” or “0” may be applied to the line.

Referring to FIG. 4D again, when an event signal is output from one of the elements included in the first column of the first group, a signal corresponding to “TRUE” or “1” may be applied to the third line. As another example, when an event signal is output from one of the elements included in the second column of the first group, a signal corresponding to “TRUE” or “1” may be applied to the fourth line. When an event signal is output from one of the elements included in the third column of the first group, a signal corresponding to “TRUE” or “1” may be applied to the fifth line. When an event signal is output from one of the elements included in the fourth column of the first group, a signal corresponding to “TRUE” or “1” may be applied to the sixth line. When an event signal is output from any one of the elements included in the fifth column of the first group, a signal corresponding to “TRUE” or “1” may be applied to the seventh line. When an event signal is output from one of the elements included in the sixth column of the first group, a signal corresponding to “TRUE” or “1” may be applied to the eighth line. When an event signal is output from one of the elements included in the seventh column of the first group, a signal corresponding to “TRUE” or “1” may be applied to the ninth line. When an event signal is output from one of the elements included in the eighth column of the first group, a signal corresponding to “TRUE” or “1” may be applied to the tenth line. When a signal corresponding to “TRUE” or “1” is applied to at least one of the third line through tenth line, a group event signal may be generated by the fourth generator 424.

Referring to FIG. 4F, the second generator 424 is connected to the elements of the first through eighth columns of the first group through pull-down circuits. The elements may control their own respective switches. For example, an element in which an event occurs may turn a switch on, and an element in which an event does not occur may turn a switch off or otherwise maintain a switch in the off position. Also, a plurality of switches may be connected to a single line.

When one of the plurality of switches connected to the single line is turned on, a supply voltage (VDD voltage) may be applied to the line. In this example, a signal corresponding to “TRUE” or “1” may be applied to the line. Conversely, when all of the switches connected to the single line are turned off, a ground (GND) voltage may be applied to the line. In this example, it may be interpreted that a signal corresponding to “FALSE” or “0” is applied to the line.

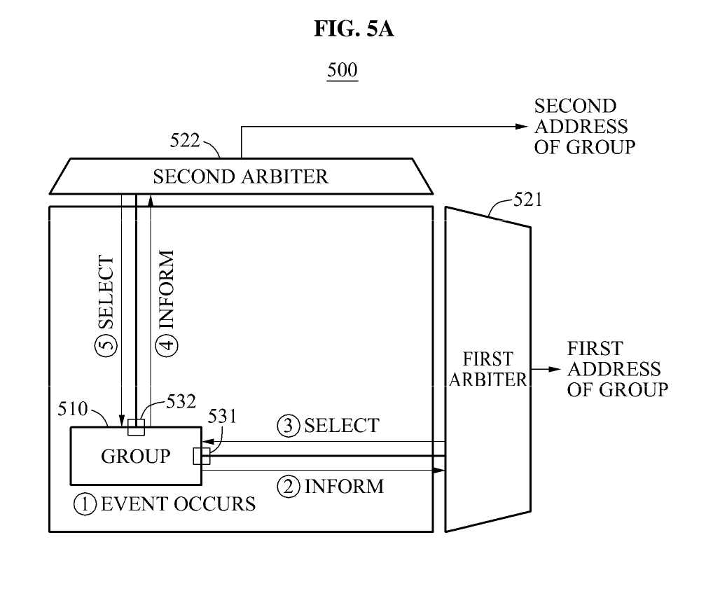

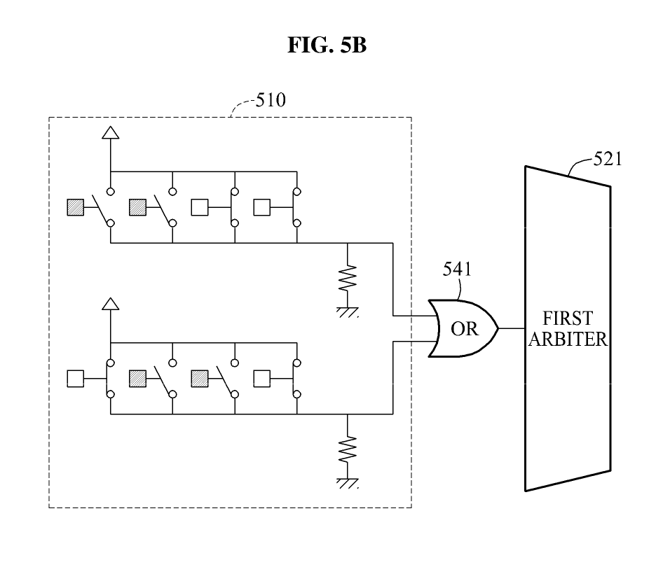

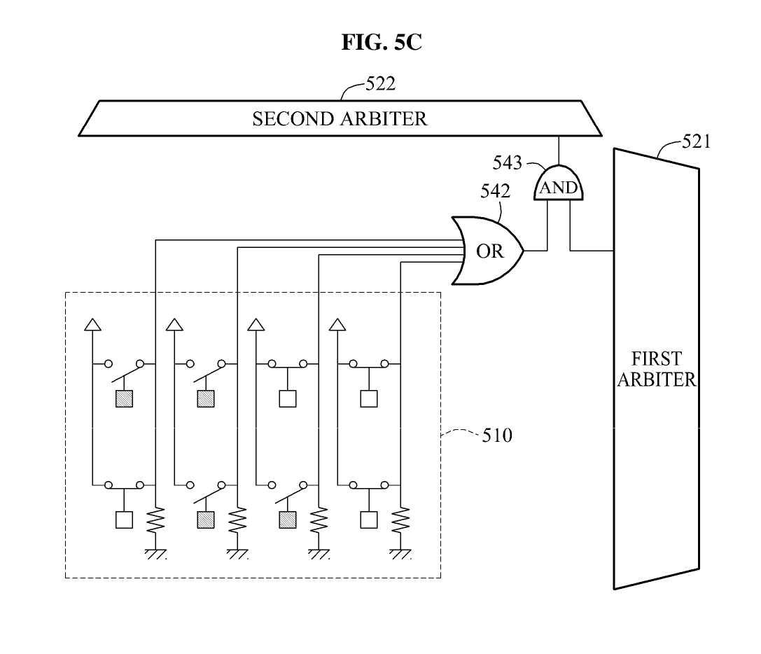

FIGS. 5A through 5C illustrate operations of an interfacing apparatus 500 according to exemplary embodiments.

Referring to FIG. 5A, the interfacing apparatus 500 includes a first arbiter 521 and a second arbiter 522. The interfacing apparatus 500 further includes a grouping unit 531 for a first direction, and a grouping unit 532 for a second direction. As a non-limiting example, the first direction may be a horizontal direction, and the second direction may be a vertical direction. A configuration of the interfacing apparatus 500 may correspond to the example shown in FIG. 4C.

An occurrence of an event may be sensed by at least one of a plurality of elements included in group 510. For example, an element in which an event occurs in the group 510 may generate an event signal. The grouping unit 531 for the first direction of the group 510 may receive the event signal from the element in which an event occurs and generate a first group event signal corresponding to the group 510. The first group event signal may inform of an occurrence of an event in the group 510 in the first direction. Referring to FIG. 5B, elements in the group 510 are connected to an OR gate 541 through pull-down circuits. In this example, the OR gate 541 may generate a first group event signal.

The first arbiter 521 may receive the first group event signal. For example, the first arbiter 521 may select the first group event signal, and output a first address of the group 510 based on the selected first group event signal. In this example, the first address of the group 510 may be an address corresponding to a y-coordinate of the group 510.

The grouping unit 532 for the second direction of the group 510 may receive the event signal from the element in which an event occurs in the group 510, and generate a second group event signal corresponding to the group 510. For example, the second group event signal may inform of an occurrence of an event in the group 510 in the second direction. Referring to FIG. 5C, elements in the group 510 are also connected to an OR gate 542 through pull-down circuits. In this example, the OR gate 542 may generate a second group event signal.

The second group event signal may be transmitted to the second arbiter 522 after a selection signal is received from the first arbiter 521. Referring to FIG. 5C, a second group event signal generated by the OR gate 542 and a selection signal generated by the first arbiter 521 may be transmitted to the second arbiter 522 through an AND gate 543 which outputs a signal correspondingly.

The second arbiter 522 may select the second group event signal, and output a second address of the group 510 based on the selected second group event signal. For example, the second address of the group 510 may be an address corresponding to an x-coordinate of the group 510.

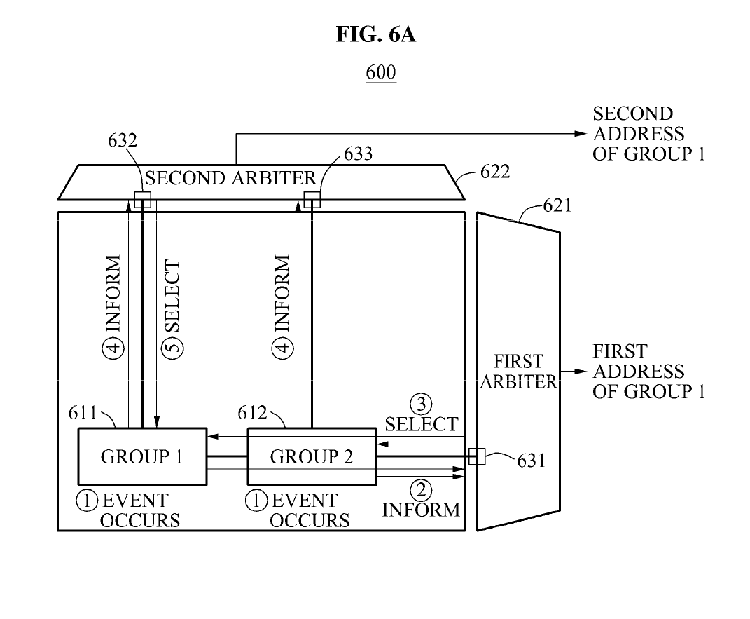

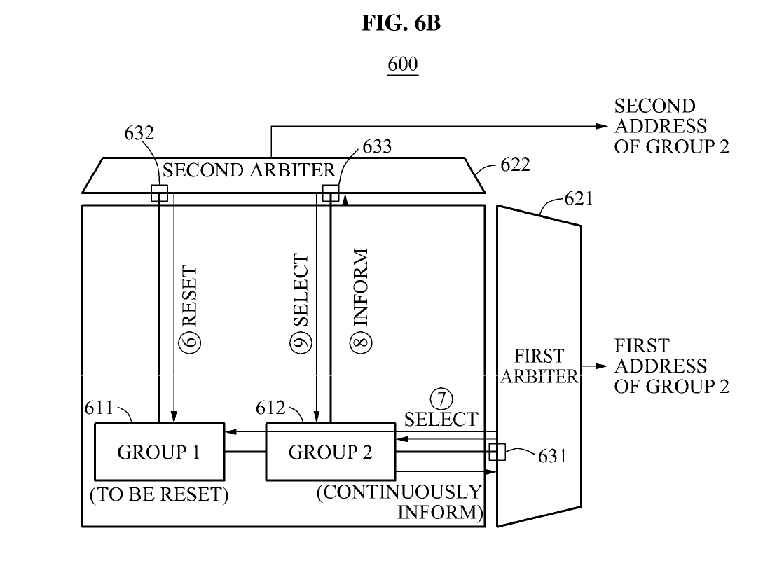

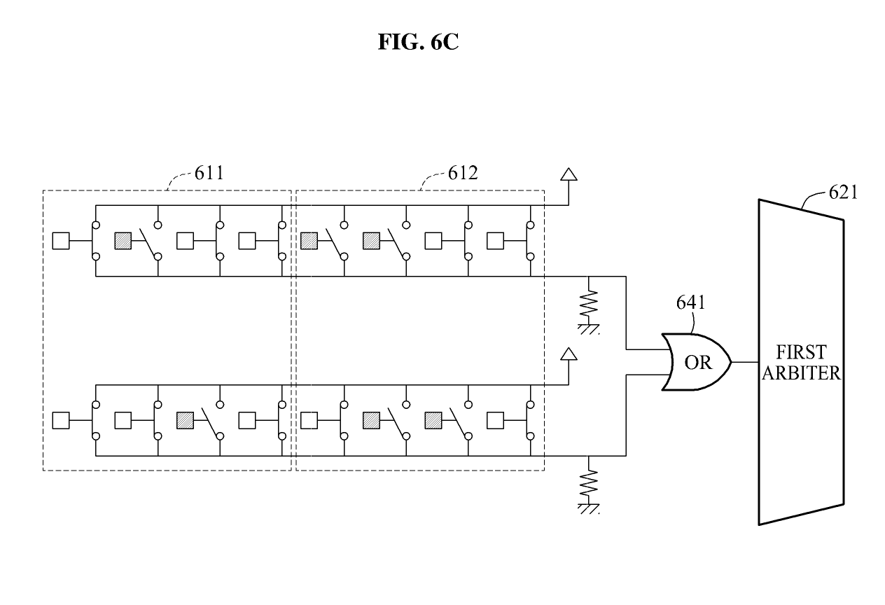

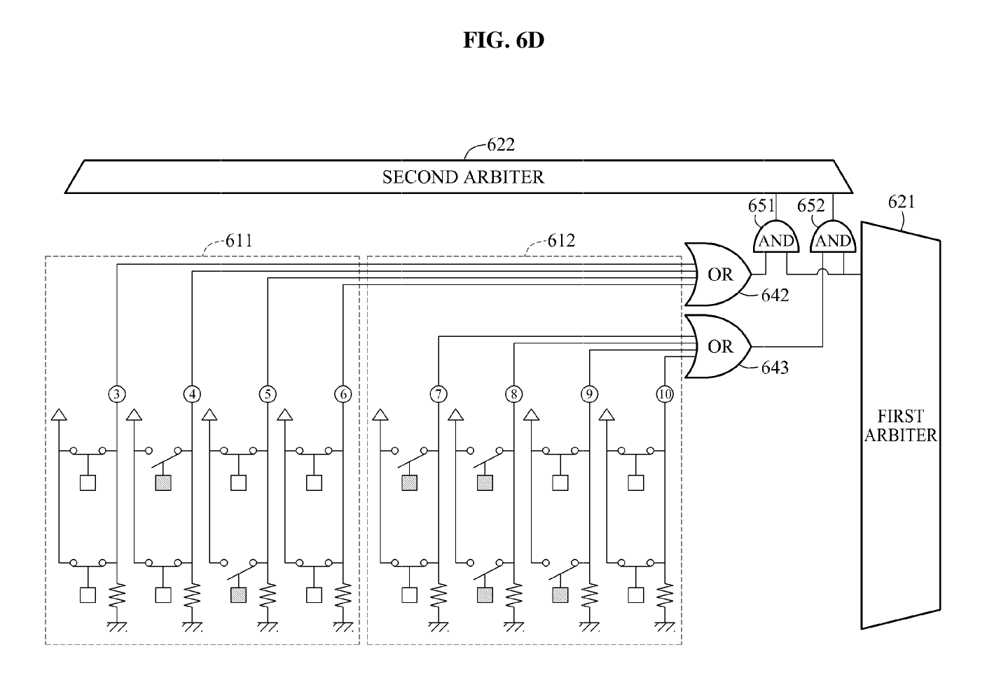

FIGS. 6A through 6D illustrate operations of an interfacing apparatus 600 according to other exemplary embodiments.

Referring to FIG. 6A, the interfacing apparatus 600 includes a first arbiter 621 and a second arbiter 622. In one or more exemplary embodiments, the interfacing apparatus 600 may further include a first grouping unit 631 for a first direction of a first group 611 and a first direction of a second group 612, a second grouping unit 632 for a second direction of the first group 611, and a third grouping unit 633 for a second direction of the second group 612. For example, the first directions may be horizontal directions, and the second directions may be vertical directions. A configuration of the interfacing apparatus 600 may be an example of apparatus as shown in FIG. 4C.

An occurrence of an event may be sensed in at least one element included in the first group 611 and at least one element included in the second group 612. In response, an element in which an event occurs in the first group 611 and an element in which an event occurs in the second group 612 may generate event signals. The first grouping unit 631 for the first direction of the first group 611 and the first direction of the second group 612 may receive the event signals from the element in which the event occurs in the first group 611 and the element in which the event occurs in the second group 612, and generate a first group event signal corresponding to the first group 611 and the second group 612. In this example, the first group event signal may be a signal informing that an event occurs in a row common to the first group 611 and the second group 612. Referring to FIG. 6C, elements in the first group 611 and elements in the second group 612 are connected to an OR gate 641 through pull-down circuits. The OR gate 641 may generate a first group event signal and output the signal to the first arbiter 621.

The first arbiter 621 may receive the first group event signal. The first arbiter 621 may select the first group event signal, and output a first address common to the first group 611 and the second group 612 based on the selected first group event signal. For example, the first address may be an address corresponding to a y-coordinate common to the first group 611 and the second group 612.

The second grouping unit 632 for the second direction of the first group 611 may receive the event signal from the element in which an event occurs in the first group 611, and generate a second group event signal corresponding to the first group 611. For example, the second group event signal may inform of an occurrence of an event in the first group 611 in the second direction. Referring to FIG. 6D, elements in the first group 611 are connected to an OR gate 642 through pull-down circuits. The OR gate 642 may generate a second group event signal.

The second group event signal may be transmitted to the second arbiter 622 after a selection signal is received from the first arbiter 621. Referring to FIG. 6D, for example, the second group event signal generated by the OR gate 642 and a selection signal generated by the first arbiter 621 may be transmitted to the second arbiter 622 through an AND gate 651.

The third grouping unit 633 (shown in FIG. 6B) for the second direction of the second group 612 may receive the event signal from the element in which an event occurs in the second group 612, and generate a third group event signal corresponding to the second group 612. The third group event signal may inform of an occurrence of an event in the second group 612 in the second direction. Referring again to FIG. 6D, elements in the second group 612 are connected to an OR gate 643 through pull-down circuits. The OR gate 643 may generate a third group event signal.

The third group event signal may be transmitted to the second arbiter 622 after a selection signal is received from the first arbiter 621. Referring to FIG. 6D, in this example, the third group event signal generated by the OR gate 643 and a selection signal generated by the first arbiter 621 may be transmitted to the second arbiter 622 through an AND gate 652.

The second arbiter 622 may receive the second group event signal and the third group event signal. When a plurality of group event signals are received, the second arbiter 622 may select one of the group event signals. For example, the second arbiter 622 may select one of the group event signals at random. As another example, the second arbiter 622 may select a group event signal corresponding to a smallest x-coordinate from among the plurality of group event signals or an event signal corresponding to an x-coordinate that is above or below a threshold. The second arbiter 622 may select a group event signal corresponding to a greatest x-coordinate from among the plurality of group event signals. A method of selecting one of the group event signals by the second arbiter 622 may be variously modified. Hereinafter, a non-limiting example in which a second group event signal is selected by the second arbiter 622 is described.

The second arbiter 622 may select the second group event signal, and output a second address of the first group 611 based on the selected second group event signal. For example, the second address of the first group 611 may be an address corresponding to an x-coordinate of the first group 611.

Referring to back again to FIG. 6B, the second arbiter 622 may reset the first group 611. The second arbiter 622 may apply a reset signal to a plurality of elements included in the first group 611. The plurality of elements in the first group 611 may be reset in response to the reset signal.

An element in which an event occurs in the second group 612 may continuously output an event signal. For example, the first grouping unit 631 for the first direction of the second group 612 may receive the event signal from the element in which an event occurs in the second group 612, and generate a first group event signal corresponding to the second group 612. The first group event signal may inform of an occurrence of an event in the second group 612.

The first arbiter 621 may receive the first group event signal. In this example, the first arbiter 621 may select the first group event signal, and output a first address of the second group 612 based on the selected first group event signal. The first address of the second group 612 may be an address corresponding to a y-coordinate of the second group 612.

The third grouping unit 633 for the second direction of the second group 612 may receive the event signal from the element in which an event occurs in the second group 612, and generate a third group event signal corresponding to the second group 612. The third group event signal may then be transmitted to the second arbiter 622 after a selection signal is received from the first arbiter 621.

The second arbiter 622 may receive the third group event signal. The second arbiter 622 may select the third group event signal, and output a second address of the second group 612 based on the selected third group event signal. For example, the second address of the second group 612 may be an address corresponding to an x-coordinate of the second group 612.

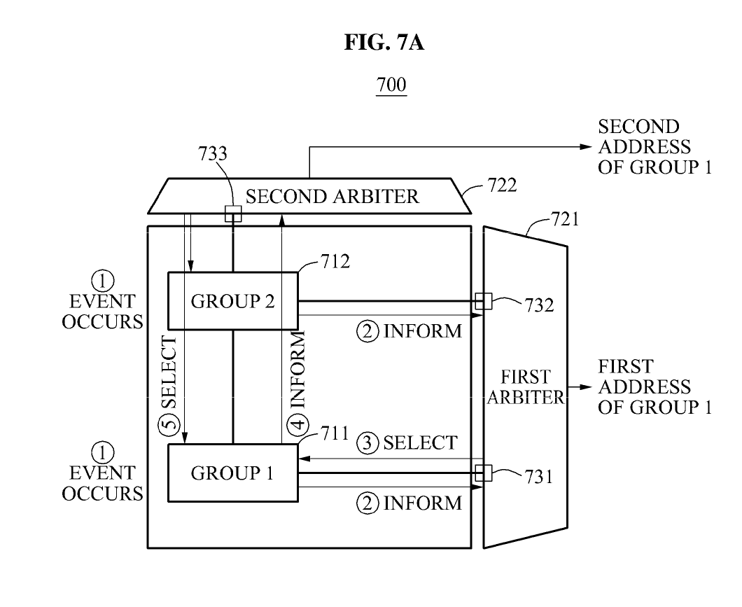

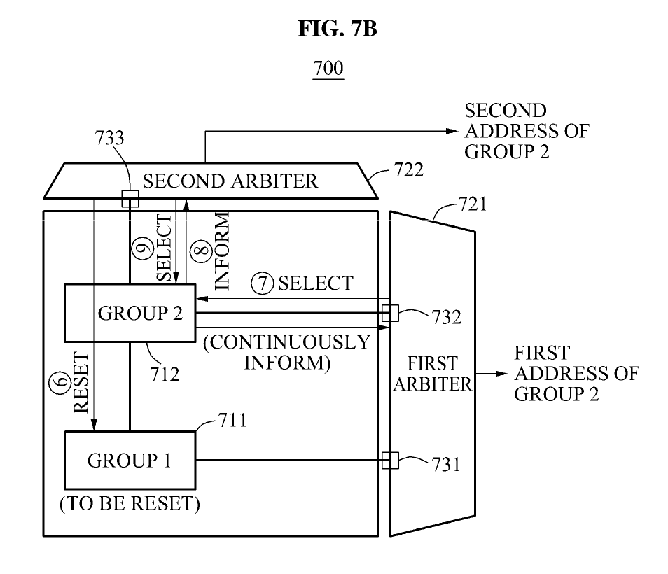

FIGS. 7A through 7B illustrate operations of an interfacing apparatus 700 according to other exemplary embodiments.

Referring to FIG. 7A, the interfacing apparatus 700 includes a first arbiter 721 and a second arbiter 722. The interfacing apparatus 700 further includes a first grouping unit 731 for a first direction of a first group 711, a second grouping unit 732 for a first direction of a second group 712, and a third grouping unit 733 for a second direction of the first group 711 and a second direction of the second group 712. For example, the first directions may be horizontal directions, and the second directions may be vertical directions. An example of the interfacing apparatus 700 may correspond to the apparatus as shown in FIG. 4C.

An occurrence of an event may be sensed in at least one element included in the first group 711 and at least one element included in the second group 712. In response, an element in which an event occurs in the first group 711 and an element in which an event occurs in the second group 712 may generate event signals. The first grouping unit 731 for the first direction of the first group 711 may receive the event signal from the element in which an event occurs in the first group 711, and generate a first group event signal corresponding to the first group 711. The second grouping unit 732 for the first direction of the second group 712 may receive the event signal from the element in which an event occurs in the second group 712, and generate a second group event signal corresponding to the second group 712. In this example, the first group event signal may be a signal used to inform of an occurrence of an event in the first group 711, and the second group event signal may be a signal used to inform of an occurrence of an event in the second group 712. Elements in the first group 711 and elements in the second group 712 are connected to an OR gate through pull-down circuits, as shown in FIG. 5B.

The first arbiter 721 may receive the first group event signal and the second group event signal. According to one or more exemplary embodiments, when a plurality of group event signals are received, the first arbiter 721 may select one of the group event signals. For example, the first arbiter 721 may select one of the group event signals at random. As a non-limiting example, the first arbiter 721 may select a group event signal corresponding to a smallest x-coordinate from among the plurality of group event signals. As another example, the first arbiter 721 may select a group event signal corresponding to a greatest x-coordinate from among the plurality of group event signals. It should also be appreciated that a method of selecting one of the group event signals by the first arbiter 721 may be variously modified. Hereinafter, an example in which a first group event signal is selected by the first arbiter 721 is described.

The first arbiter 721 may select the first group event signal, and output a first address of the first group 711 based on the selected first group event signal. For example, the first address of the first group 711 may be an address corresponding to a y-coordinate of the first group 711.

The third grouping unit 733 that is used for the second direction of the first group 711 may receive the event signal from the element in which an event occurs in the first group 711, and generate a third group event signal corresponding to the first group 711. The third group event signal may be a signal informing of an occurrence of an event in the first group 711 in the second direction. For example, elements in the first group 711 may be connected to an OR gate through pull-down circuits, as shown in FIG. 5C. The third group event signal may be transmitted to the second arbiter 722 after a selection signal is received from the first arbiter 721.

The second arbiter 722 may select the third group event signal, and output a second address of the first group 711, for example, based on the selected third group event signal. In some cases, the second address of the first group 711 may be an address corresponding to an x-coordinate of the first group 711.

Referring to FIG. 7B, the second arbiter 722 may reset the first group 711. The second arbiter 722 may apply a reset signal to a plurality of elements that are included in the first group 711. The plurality of elements in the first group 711 may be reset in response to the reset signal. For example, the plurality of elements in the first group 711 may be reset in response to the reset signal of the second arbiter 722 and a selection signal of the first arbiter 721.

As an example, an element in which an event occurs in the second group 712 may continuously output an event signal. The second grouping unit 732 for the first direction of the second group 712 may receive the event signal from the element in which an event occurs in the second group 712, and generate a second group event signal corresponding to the second group 712. For example, the second group event signal may be a signal informing of an occurrence of an event in the second group 712.

The first arbiter 721 may receive the second group event signal. The first arbiter 721 may select the second group event signal, and output a first address of the second group 712 based on the selected second group event signal. For example, the first address of the second group 712 may be an address corresponding to a y-coordinate of the second group 712.

The third grouping unit 733 for the second direction of the second group 712 may receive the event signal from the element in which an event occurs in the second group 712, and generate a third group event signal corresponding to the second group 712. In response, the third group event signal may be transmitted to the second arbiter 722 after a selection signal is received from the first arbiter 721.

The second arbiter 722 may receive the third group event signal. The second arbiter 722 may select the third group event signal, and output a second address of the second group 712 based on the selected third group event signal. For example, the second address of the second group 712 may be an address corresponding to an x-coordinate of the second group 712.

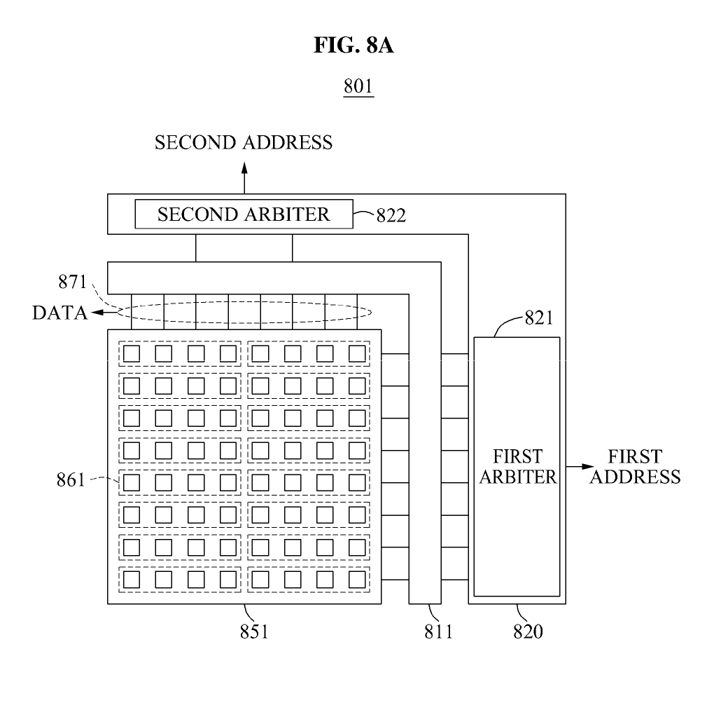

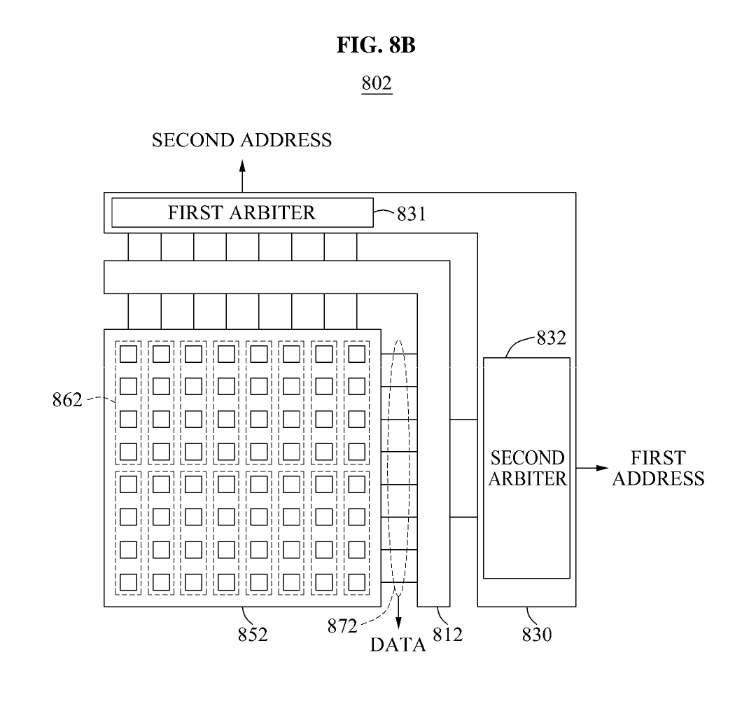

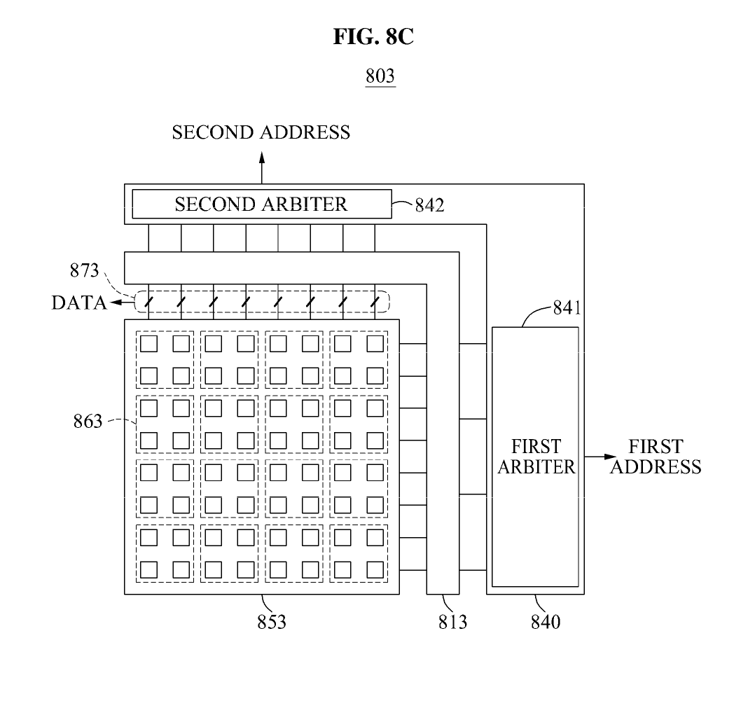

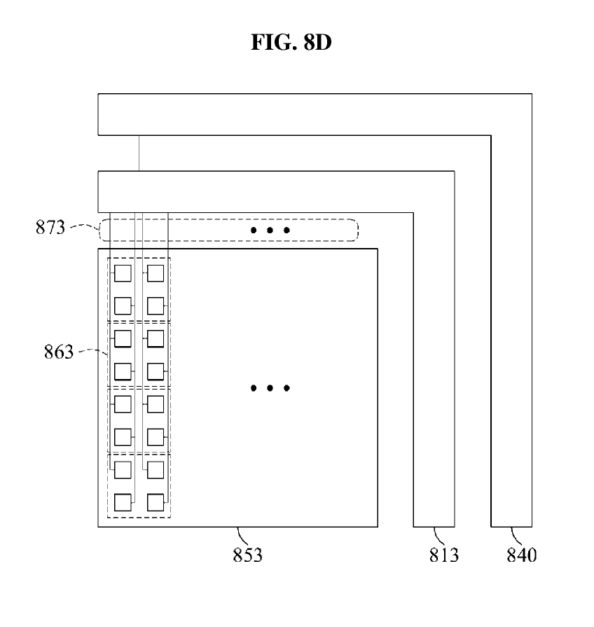

FIGS. 8A through 8D illustrate examples of obtaining data of a group.

Referring to FIG. 8A, an interfacing apparatus 801 includes a grouping unit 811 and an interface 820. Event generation elements 851 may be grouped in a row direction. In this example, the event generation elements 851 are grouped in groups of a 4×1 horizontal lines in successive form.

The grouping unit 811 may generate a first group event signal by grouping first event signals of the event generation elements 851, and generate a second group event signal by grouping second event signals of the event generation elements 851. For example, the first event signals may be event signals output from the event generation elements 851 in a first direction, and the second event signals are event signals output from the event generation elements 851 in a second direction. Here the first direction is a row direction, and the second direction is a column direction.

The interface 820 includes a first arbiter 821 in a vertical direction and a second arbiter 822 in a horizontal direction. The first arbiter 821 may select one of at least one first group event signal in response to the at least one first group event signal. The first arbiter 821 may output a first address corresponding to the selected first group event signal. The second arbiter 822 may select a second group event signal in response to at least one second group event signal. The second arbiter 822 may output a second address corresponding to the selected second group event signal.

The interfacing apparatus 801 further includes a data output unit 871. For example, the data output unit 871 may output data of a group corresponding to the first address and the second address. The data output unit 871 may output the data of the group corresponding to the first address and the second address based on the second event signals that are output from the event generation elements 851 in the second direction.

For example, an event may occur in group 861. The first arbiter 821 may select the group 861, and output a first address of the group 861. The second arbiter 822 may select the group 861, and output a second address of the group 861. In this example, the data output unit 871 may output second event signals of the group 861 as data about the group 861 corresponding to the selected first and second addresses.

Referring to FIG. 8B, an interfacing apparatus 802 includes a grouping unit 812 and an interface 830. Event generation elements 852 may be grouped in a column direction. The event generation elements 852 may be grouped, for example, in a 1×4 form.

The grouping unit 812 may generate a first group event signal by grouping first event signals of the event generation elements 852, and generate a second group event signal by grouping of second event signals of the event generation elements 852. In this example, the first event signals may be event signals that are output from the event generation elements 852 in a first direction, and the second event signals may be event signals that are output from the event generation elements 852 in a second direction. Here, the first direction may be a row direction, and the second direction may be a column direction.

The interface 830 includes a first arbiter 831 and a second arbiter 832. The first arbiter 831 may select at least one second group event signal in response to the at least one second group event signal. The second arbiter 831 may output a second address corresponding to the selected second group event signal. The second arbiter 832 may select at least one first group event signal in response to the at least one first group event signal. The second arbiter 832 may output a first address corresponding to the selected first group event signal.

The interfacing apparatus 802 further includes a data output unit 872. The data output unit 872 may output data of a group corresponding to the first address and the second address. For example, the data output unit 872 may output the data of the group corresponding to the first address and the second address based on the first event signals output from the event generation elements 851 in the first direction.

For example, an event may occur in group 862. The first arbiter 831 may select the group 862, and output a second address of the group 862. The second arbiter 832 may select the group 862, and output a first address of the group 862. In this example, the data output unit 872 may output first event signals of the group 862 as data of the group 862 corresponding to the first address and the second address.

Referring to FIG. 8C, an interfacing apparatus 803 includes a grouping unit 813 and an interface 840. Event generation elements 853 may be grouped in the form of a two-dimensional (2D) matrix. The event generation elements 853 may be grouped in a 2×2 form. In these examples, the elements that are grouped together may be one-dimensional or two-dimensional groups of display sensors, audio sensors, processing sensors, and the like.

It should be appreciated that in one or more exemplary embodiments, a sensor for sensing an audio event and a sensor for sensing a video event may be different types of sensors, or otherwise configured differently. Therefore, in some examples, audio events can be simultaneously processed and the video events can be simultaneously processed, respectively.

The grouping unit 813 may generate a first group event signal by grouping first event signals of the event generation elements 853, and generate a second group event signal by grouping second event signals of the event generation elements 853. In these examples, the first event signals may be event signals output from the event generation elements 853 in a first direction, and the second event signals may be signals output from the event generation elements 853 in a second direction. As a non-limiting example, the first direction may be a row direction, and the second direction may be a column direction.

The interface 840 includes a first arbiter 841 and a second arbiter 842. The first arbiter 841 may select at least one first group event signal in response to the at least one first group event signal. In response, the first arbiter 841 may output a first address corresponding to the selected first group event signal. The second arbiter 842 may select at least one second group event signal in response to the at least one second group event signal. In response, the second arbiter 842 may output a second address corresponding to the selected second group event signal.

The interfacing apparatus 803 further includes a data output unit 873. For example, the data output unit 873 may output data of a group corresponding to the first address and the second address. As one non-limiting example, the data output unit 873 may output the data of the group corresponding to the first address and the second address based on the second event signals output from the event generation elements 851 in the second direction.

As an example, an event may occur in group 863. The first arbiter 841 may select the group 863, and output a first address of the group 863. The second arbiter 842 may select the group 863, and output a second address of the group 863. In this example, the data output unit 873 may output second event signals of the group 863 as data of the group 863 corresponding to the first address and the second address.

When the group 863 is selected by the first arbiter 841, the data output unit 873 may obtain output values of four elements included in the group 863. The data output unit 873 may be connected individually to all elements included in a single group among the plurality of groups. Examples of routing between the event generation elements 853 and the data output unit 873 may be the same as that shown in the example of FIG. 8D.

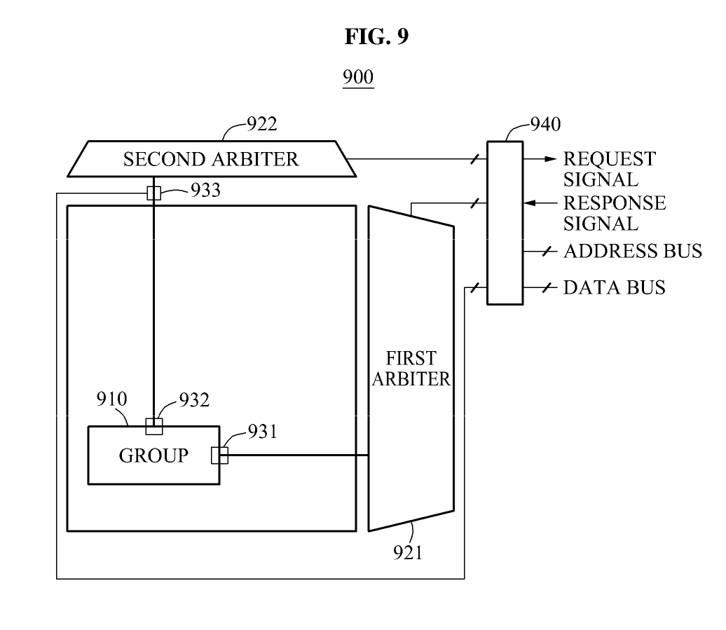

FIG. 9 illustrates an operation of an interfacing apparatus communicating with an external device according to an exemplary embodiment.

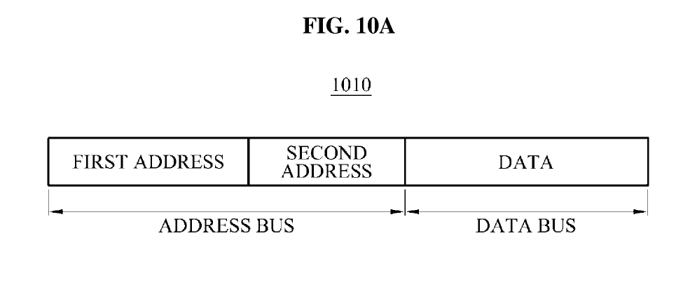

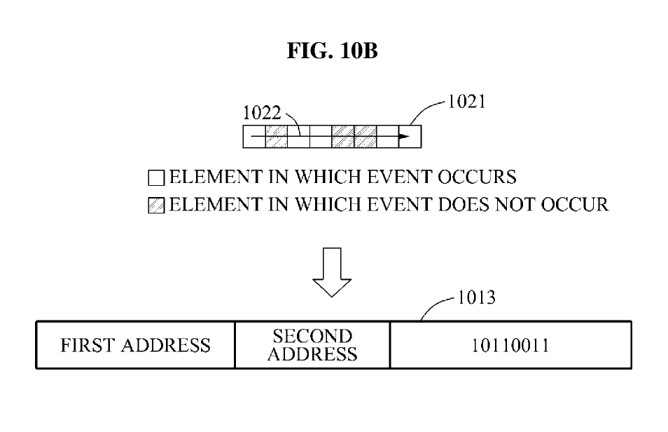

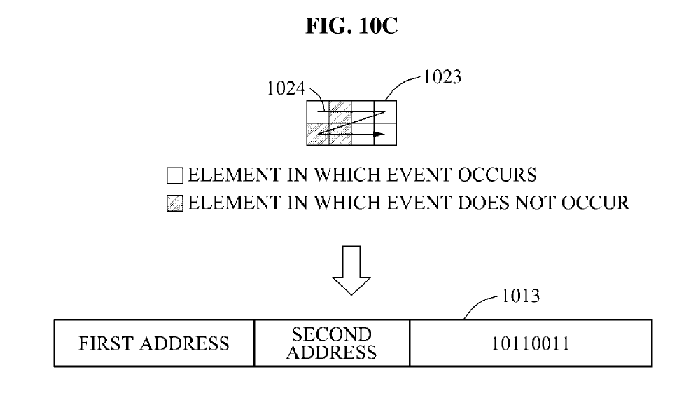

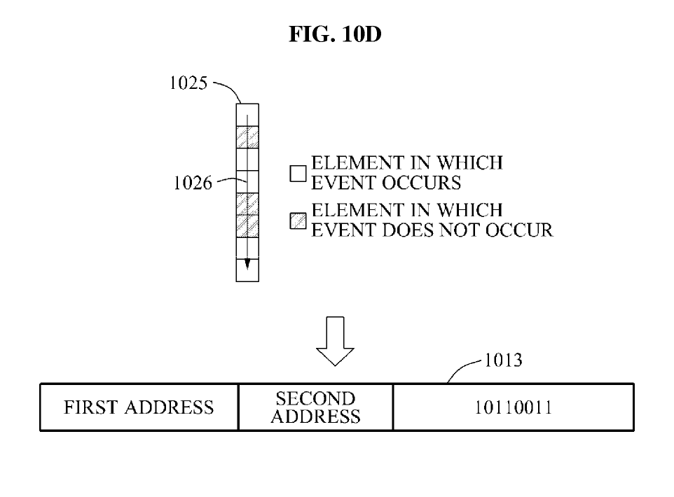

FIGS. 10A through 12 illustrate examples of various packets used by an interfacing apparatus according to exemplary embodiments.

Referring to FIG. 9, interfacing apparatus 900 includes a communication unit 940 that may communicate with an external device. When an event occurs in a group 910, a first group event signal may be generated by a first grouping unit 931, and a second group event signal may be generated by a second grouping unit 932. The first arbiter 921 may output a first address of the group 910, and a second arbiter 922 may output a second address of the group 910. A data output unit 933 may output data of the group 910.

The communication unit 940 may apply a first address and a second address of a group in which an event occurs to an address bus, and apply data of the group in which an event occurs to a data bus. Referring to FIG. 10A, the communication unit 940 may transmit a packet 1010 to an outside using the address bus and the data bus.

The communication unit 940 may further output timestamp information when applying the first address, the second address, and data of the group in which an event occurs to the address bus and the data bus. In this example, the packet 1010 may further include a timestamp field. The timestamp information refers to information about a time at which an event occurs. The communication unit 940 may further receive an output of a timer (not shown). The communication unit 940 may apply, to a timestamp bus (not shown), an output of the timer at a point in time at which an event occurs. As another example, the communication unit 940 may apply, to the timestamp bus, an output of the timer at a point in time at which the first address, the second address, and the data of the group in which an event occurs are applied to the address bus and the data bus.

The communication unit 940 may perform mapping between event generation elements in a group in which an event occurs and a plurality of bits that make up a data field of the packet 1010. Referring to FIG. 10B, when event generation elements 1021 in a group are grouped in a row direction, the communication unit 940 may configure bits of a data field 1013 of a packet based on a sequence 1022 in which the event generation elements 1021 are disposed. Referring to FIG. 10C, for example, when event generation elements 1023 in a group are grouped in the form of a matrix, the communication unit 940 may configure the bits of the data field 1013 of the packet based on a sequence 1024 in which the event generation elements 1023 are disposed. Referring to FIG. 10D, when event generation elements 1025 in a group are grouped in a column direction, the communication unit 940 may configure the bits of the data field 1013 of the packet based on a sequence 1026 in which the event generation elements 1025 are disposed. It should be appreciated that the mapping between the event generation elements and the plurality of bits that make up the data field of the packet is not limited thereto, and may be variously modified.

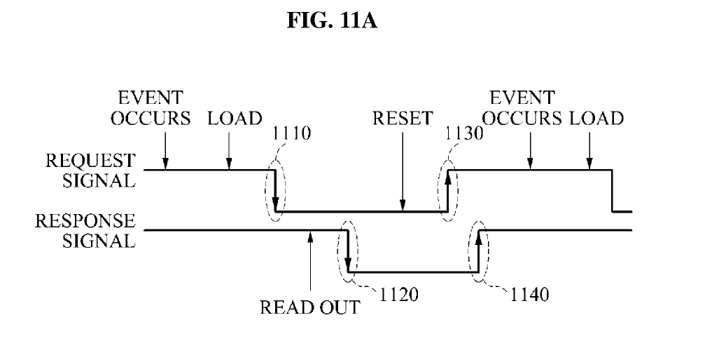

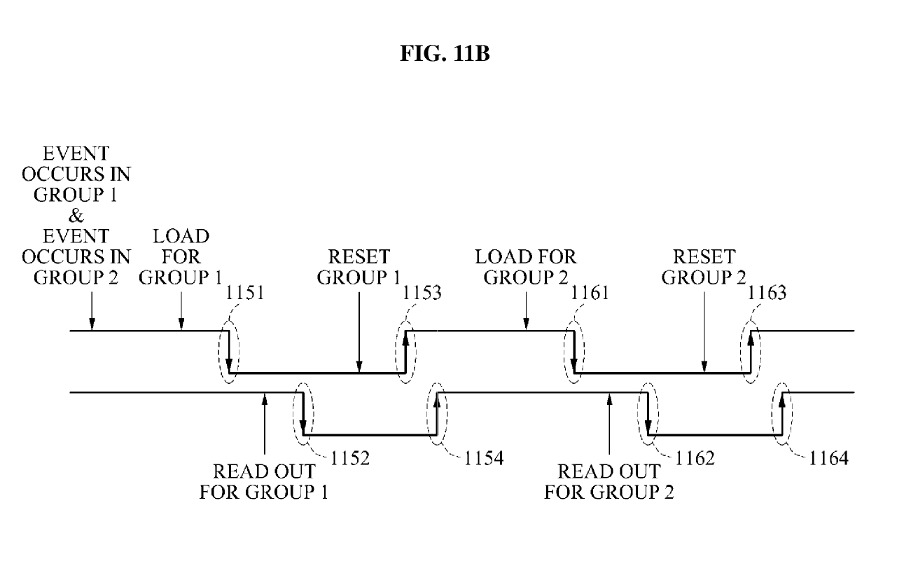

Referring to FIG. 11A, the communication unit 940 may communicate with an external device, for example, a using handshaking. The external device refers to a device that may receive an event signal from the interfacing apparatus 900, and may include, for example, a microprocessor, a hardware module configured to process an event signal, and the like.

When an address and data of a group in which an event occurs are loaded, the communication unit 940 may change a request signal from high to low. The external device communicating with the communication unit 940 may receive a falling edge 1110 of the request signal, and read out the address and the data. The external device may change a response signal from high to low when the address and the data are read out. In this example, the interfacing apparatus 900 may receive a falling edge 1120 of the response signal, and the rest the group of which the address and the data are transmitted. When the group is reset, the communication unit 940 may change the request signal from low to high. The external device may receive a rising edge 1130 of the request signal, and change the response signal from low to high. In this example, the interfacing apparatus 900 may receive a rising edge 1140 of the response signal, and iteratively perform the foregoing operation to transmit an address and data of a subsequent group in which an event occurs.

For example, the communication unit 940 may transmit a first address, a second address, and data of a group in which an event occurs to an external device using serial communication. The communication unit 940 may transmit bits included in the packet 1010 of FIG. 10A to the external device with a predetermined timing of the serial communication. A communication method of the communication unit 940 is not limited thereto, and may be variously modified. Hereinafter, for ease of description, a case in which a first address, a second address, and data of a group are transmitted through an address bus and a data bus is assumed.

Referring to FIG. 11B, when events occur simultaneously in a plurality of groups, the communication unit 940 may iteratively communicate with an external device using handshaking. For example, when events occur simultaneously in a first group and a second group, one of the groups may be selected by an arbiter.

As an example, the first group may be selected first. When an address and data of the first group are loaded, the communication unit 940 may change a request signal from high to low. The external device communicating with the communication unit 940 may receive a falling edge 1151 of a request signal, and may read out the address and the data of the first group. In response, the external device may change a response signal from high to low. The interfacing apparatus 900 may receive a falling edge 1152 of the response signal, and reset the first group in which the address and the data are transmitted. When the first group is reset, the communication unit 940 may change the request signal from low to high. Also, the external device may receive a rising edge 1153 of the request signal, and change the response signal from low to high.

After a rising edge 1154 of the response signal is received, the arbiter may select the second group. When an address and data of the second group are loaded, the communication unit 940 may change the request signal from high to low. The external device that is communicating with the communication unit 940 may receive a falling edge 1161 of the request signal, and read out the address and the data of the second group. In response, the external device may change the response signal from high to low. The interfacing apparatus 900 may receive a falling edge 1162 of the response signal, and reset the second group of which the address and the data are transmitted. In response, the communication unit 940 may change the request signal from low to high. The external device may receive a rising edge 1163 of the request signal, and change the response signal from low to high. The interfacing apparatus 900 may receive a rising edge 1164 of the response signal, and iteratively perform the foregoing operation to transmit an address and data of a subsequent group in which an event occurs.

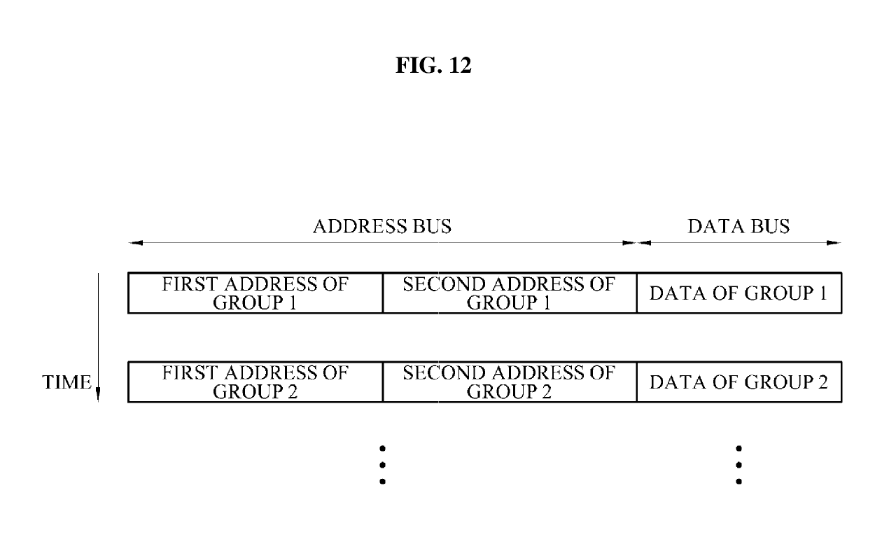

Information applied to the address bus and the data bus may change over time, as shown in FIG. 12. In this example, the address bus may have a bandwidth that is capable of transmitting the first address and the second address of the group in which an event occurs, while the data bus may have a bandwidth that is capable of transmitting the data of the group in which an event occurs.

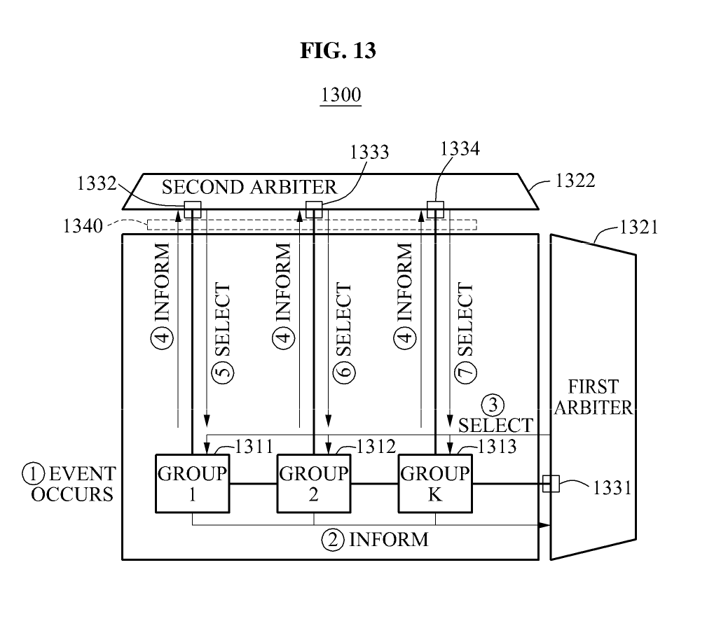

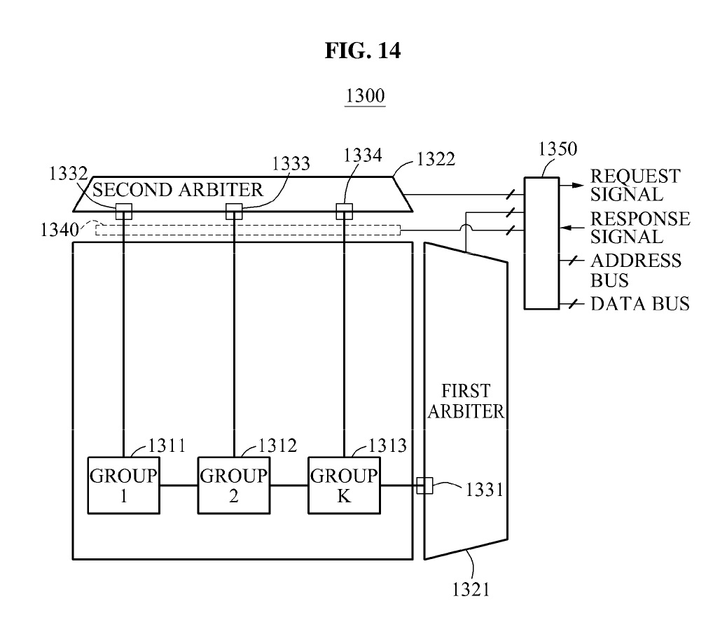

FIGS. 13 through 14 illustrate operations of an interfacing apparatus 1300 according to other exemplary embodiments.

Referring to FIG. 13, the interfacing apparatus 1300 includes a first arbiter 1321 and a second arbiter 1322. The interfacing apparatus 1300 further includes a first grouping unit 1331 for a first direction of a first group 1311, a first direction of a second group 1312, and a first direction of a k-th group 1313. The interfacing apparatus 1300 further includes a grouping unit 1332 for a second direction of the first group 1311, a grouping unit 1333 for a second direction of the second group 1312, and a grouping unit 1334 for a second direction of the k-th group 1313. In this example, the first directions may be horizontal directions, and the second directions may be vertical directions. An example of the interfacing apparatus 1300 may correspond to the example apparatus as shown in FIG. 4C.

Events may occur simultaneously in a plurality of groups classified in an identical row. For example, an occurrence of events may be sensed simultaneously in at least one element that is included in the first group 1311, at least one element included in the second group 1312, and at least one element included in the k-th group 1313.

Each of these events may generate event signals. The grouping unit 1331 for the first direction of the first group 1311, the first direction of the second group 1312, and the first direction of the k-the group 1313 may receive the event signals from the element in which the respective event occurs, and generate a first group event signal corresponding to a row common to the first group 1311, the second group 1312, and the k-th group 1313. The first group event signal may be a signal informing of an occurrence of an event in the row common to the first group 1311, the second group 1312, and the k-th group 1313.

The first arbiter 1321 may receive the first group event signal. The first arbiter 1321 may select the first group event signal, and output a first address common to the first group 1311, the second group 1312, and the k-th group 1313 based on the selected first group event signal. In this example, the first address may be an address corresponding to a y-coordinate that is common to the first group 1311, the second group 1312, and the k-th group 1313.

For example, the grouping unit 1332 for the second direction of the first group 1311 may receive the event signal from the element in which an event occurs in the first group 1311, and the grouping unit 1332 may generate a second group event signal corresponding to the first group 1311. The second group event signal may be a signal informing of an occurrence of an event in the first group 1311 in the second direction. The second group event signal may be transmitted to the second arbiter 1322, for example, after a selection signal is received from the first arbiter 1321.

For example, the grouping unit 1333 for the second direction of the second group 1312 may receive the event signal from the element in which an event occurs in the second group 1312, and the grouping unit 1333 may generate a third group event signal corresponding to the second group 1312. The third group event signal may be a signal informing of an occurrence of an event in the second group 1312 in the second direction. Also, the third group event signal may be transmitted to the second arbiter 1322, for example, after a selection signal is received from the first arbiter 1321.

For example, the grouping unit 1334 for the second direction of the k-th group 1313 may receive the event signal from the element in which an event occurs in the k-th group 1313, and the grouping unit 1334 may generate a fourth group event signal corresponding to the k-th group 1313. The fourth group event signal may be a signal informing of an occurrence of an event in the k-th group 1313 in the second direction. The fourth group event signal may be transmitted to the second arbiter 1322 after a selection signal is received from the first arbiter 1321.

The second arbiter 1322 may receive the second group event signal, the third group event signal, and the fourth group event signal. When a plurality of group event signals are received, the second arbiter 1322 may iteratively select a group event signal. For example, the second arbiter 1322 may sequentially select the second group event signal, the third group event signal, and the fourth group event signal. For example, the second arbiter 1322 may select the second group event signal, the third group event signal, and the fourth group event signal in a random sequence. It should also be appreciated that the example method of iteratively selecting a group event signal by the second arbiter 1322 may be variously modified. Hereinafter, an example in which the second group event signal, the third group event signal, and the fourth group event signal are sequentially selected by the second arbiter 1322 is described.

The second arbiter 1322 may select the second group event signal, and output a second address of the first group 1311 based on the selected second group event signal. For example, the second address of the first group 1311 may be an address corresponding to an x-coordinate of the first group 1311. The data output unit 1340 may also output data of the first group 1311.

The second arbiter 1322 may select the third group event signal, and output a second address of the second group 1312 based on the selected third group event signal. For example, the second address of the second group 1312 may be an address corresponding to an x-coordinate of the second group 1312. The data output unit 1340 may also output data of the second group 1312.

The second arbiter 1322 may select the fourth group event signal, and output a second address of the k-th group 1313 based on the selected fourth group event signal. For example, the second address of the k-th group 1313 may be an address corresponding to an x-coordinate of the k-th group 1313. The data output unit 1340 may also output data of the k-th group 1313.

The second arbiter 1322 may reset the first group 1311, the second group 1312, and the k-th group 1313. In an example, the second arbiter 1322 may reset the first group 1311 after the second address of the first group 1311 is successfully transmitted. The second arbiter 1322 may reset the second group 1312 after the second address of the second group 1312 is successfully transmitted. Also, the second arbiter 1322 may reset the k-th group 1313 after the second address of the k-th group 1313 is successfully transmitted. For example, the second arbiter 1322 may reset the first group 1311, the second group 1312, and the k-th group 1313 together after the second address of the k-th group 1313 is successfully transmitted.

Referring to FIG. 14, the interfacing apparatus 1300 further includes a communicator 1350 that may communicate with an external device. For example, the communicator 1350 may communicate with the external device using handshaking. The external device may be a device that receives an event signal from the interfacing apparatus 1300, and may include, for example, a microprocessor, a hardware module configured to process an event signal, and the like.

When the first address corresponding to the row that is common to the first group 1311, the second group 1312, and the k-th group 1313 is output by the first arbiter 1321, the communicator 1350 may apply the first address to an address bus. The communicator 1350 may transmit the first address to the external device using handshaking.

When the second address of the first group 1311 is output by the second arbiter 1322, the communicator 1350 may apply the second address of the first group 1311 to the address bus. When the data of the first group 1311 is output by the data output unit 1340, the communicator 1350 may apply the data of the first group 1311 to a data bus. The communicator 1350 may transmit the second address and the data of the first group 1311 to the external device using handshaking.

When the second address of the second group 1312 is output by the second arbiter 1322, the communicator 1350 may apply the second address of the second group 1312 to the address bus. When the data of the second group 1312 is output by the data output unit 1340, the communicator 1350 may apply the data of the second group 1312 to the data bus. The communicator 1350 may transmit the second address and the data of the second group 1312 to the external device using handshaking.

When the second address of the k-th group 1313 is output by the second arbiter 1322, the communicator 1350 may apply the second address of the k-th group 1313 to the address bus. When the data of the k-th group 1313 is output by the data output unit 1340, the communicator 1350 may apply the data of the k-th group 1313 to the data bus. The communicator 1350 may transmit the second address and the data of the k-th group 1313 to the external device using handshaking.

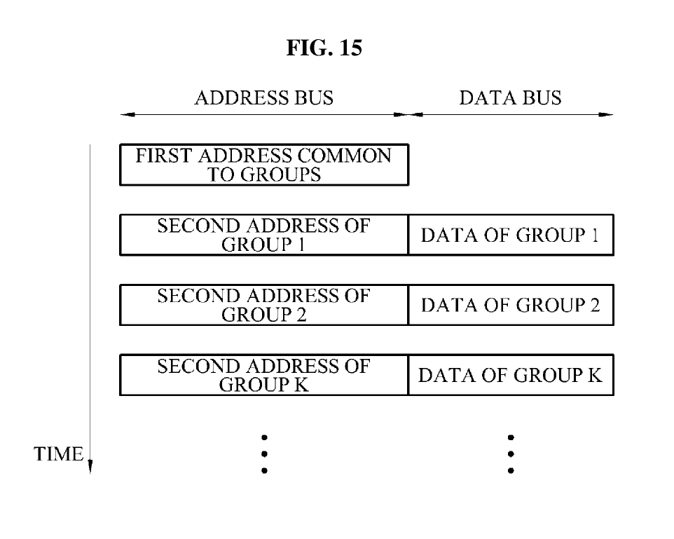

FIG. 15 illustrates information applied to an address bus and a data bus that may change over time;

Information applied to the address bus and the data bus may change over time, as shown in FIG. 15. In this example, the address bus may transmit a first address and a second address, separately, and thus, the address but may have a reduced bandwidth in comparison to the address bus of FIG. 12.

As described herein, one or more exemplary embodiments provide a technology that may simultaneously processes a plurality of groups having the same first address or line address. Accordingly, a line address arbitration time occurring while processing each group may be shared among a plurality of groups that are disposed on the same line in the group. In addition, a group reset time occurring when processing each group may be shared among a plurality of groups disposed on the same line in the group.

The communicator 1350 may further output timestamp information when applying a first address, a second address, and data of a group in which an event occurs to the address bus and the data bus. The communication unit 1350 may further receive an output of a timer. The communication unit 1350 may apply an output of the timer at a point in time at which an event occurs to a timestamp bus. The communication unit 1350 may apply, to the timestamp bus, an output of the timer at a point in time at which the first address, the second address, and data of the group in which an event occurs are applied to the address bus and the data bus.

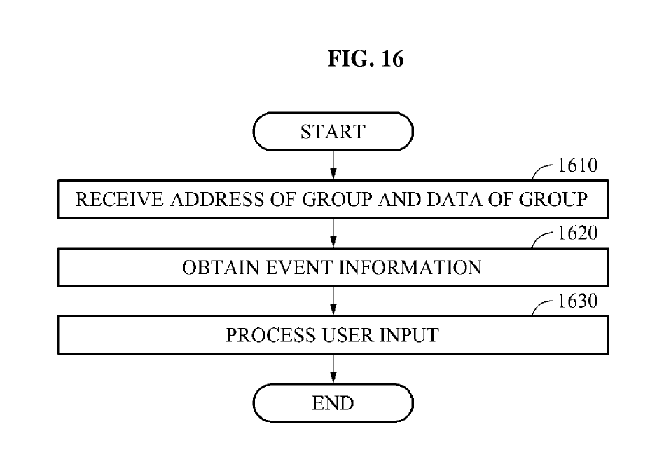

FIG. 16 illustrates a user input processing method according to an exemplary embodiment.

Referring to FIG. 16, the user input processing method includes operation 1610 of receiving an address and data of a group in which an event occurs in response to a user input. Also, operation 1620 of obtaining event information based on the address, the data, and grouping information of the group, and operation 1630 of processing the user input based on the event information.

The group may include event generation elements disposed consecutively in a predetermined pattern. The address of the group may be an address representing the event generation elements that belong to the group. The grouping information may include dimension information of the group, and information on mapping between a plurality of bits including in the data of the group and the event generation elements of the group.

For example, 1610 may include receiving a request signal, reading out a first address of the group, reading out a second address of the group, reading out the data of the group, and transmitting a response signal. Operation 1610 may include receiving a first address common to a plurality of groups, and iteratively receiving items of data of the plurality of groups and second addresses that may be used to distinguish the plurality of groups.

The receiving of the first address may include receiving a first request signal, reading out the first address, and transmitting a first response signal. For example, the iteratively receiving may include receiving a second request signal, reading out a currently received second address from among the second addresses, reading out currently received data from among the items of data, and transmitting a second response signal.

The obtaining of the event information may include calculating reference coordinates corresponding to the address of the group, and calculating coordinates of at least one pixel in which an event occurs based on the reference coordinates, the data of the group, and the grouping information of the group.

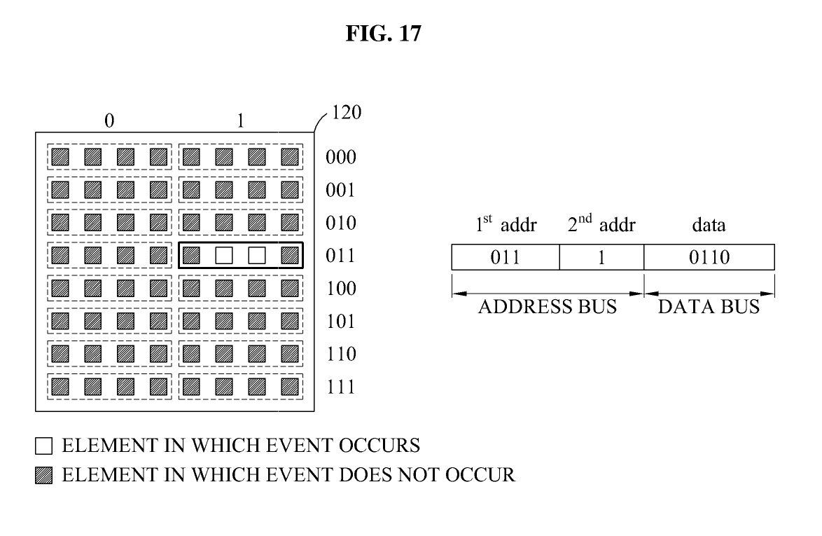

FIG. 17 is a diagram illustrating an address bus and a data bus, such as that shown in the example of FIG. 10A, which are used to identify a group of elements in which an event occurs such as shown in the example of FIG. 15, according to an exemplary embodiment.

Referring to FIG. 17, the 1^{st} address ‘011’ is used to identify a row in which the grouped event is located, the 2^{nd} address ‘1’ is used to identify which side (i.e. right side) of the row in which the group event is located, and the data ‘0110’ identifies the elements in the combination of the row and the side in which the event occurs.

Exemplary embodiments may be applied to manufacture and control a high-capacity neuromorphic chip such as, for example, a high-resolution event-based sensor. For example, a maximum event occurrence rate in a 128×128 event-based sensor may be 2 mega events per second (Meps). When a resolution of the event-based sensor is increased to 640×480, the maximum event occurrence rate may increase to 20 Meps. When the event occurrence rate is increased to be greater than or equal to a threshold value, an event data obtaining rate may considerably decrease. One or more exemplary embodiments may resolve a decrease in an event data obtaining rate when there is an increase in a number of pixels such as dynamic-vision sensor (DVS) pixels in a high-resolution event-based sensor.

One or more exemplary embodiments provide a technology that obtains event data, for example, in a high-resolution event-based sensor without increasing a clock rate at which a circuit is to operate. As will be appreciated, when a clock rate of a circuit increases, power consumption may also increase. Accordingly, one or more exemplary embodiments provide an interface technology that increases an event data obtaining rate without increasing clock cycle and reducing power consumption.

One or more exemplary embodiments provide examples of a video interface that increase a bandwidth for event data by dividing a plurality of event generation elements, such as elements that detect light changing events, into groups, and simultaneously process the event signals generated in the groups. Thus, a processing delay and an event loss rate may decrease. In addition, one or more exemplary embodiments may reduce input-output (IO) power consumption. For example, one or more exemplary embodiments may reduce dynamic power consumption for IO.

One or more exemplary embodiments provide examples that reduce a cycle of handshaking for data transmission. Thus, a limit to an event data obtaining rate may be increased.

One or more exemplary embodiments provide examples that control a group size. The group size refers to a number of elements included in a single group of sensors such as display sensors, audios sensors, various processing sensors, and the like. For example, as the group size increases, an event processing rate may increase. As the group size increases, a size of an address bus may increase. When the size of the address bus increases, IO power consumption may also increase. Thus, when the group size increases, a trade-off between the event processing rate and the power consumption may occur. On or more exemplary embodiments provide examples that may select a candidate group size with a smallest size of an address bus or a size below a threshold value from among candidate group sizes that are used to provide at least a desired event processing rate. In an example, a group size for a 640×480 event-based sensor may be set to “8”.

One or more exemplary embodiments provide a technology that reduces a processing delay and an event loss rate by increasing a bandwidth while maintaining an advantage of event-driven acquisition within image sensors, photodiodes, and the like.

For example, one or more exemplary embodiments provide a technology that may simultaneously process events occurring in a group by dividing a number of elements into groups. Thus, the present disclosure may reduce a resolution in an aspect of acquisition of images.

In one or more exemplary embodiments, it may be possible to process multiple groups of events simultaneously through a single interface. For example, in one embodiment the apparatus may simultaneously process multiple groups of elements through a single interface. In some examples, it may be better to use one large group instead of using multiple small groups.

According to one or more exemplary embodiments, provided is an apparatus similar to a related art event acquisition apparatus in that a group arbiter and a line arbiter may issue the same type of commands. One difference though is that instead of issuing a point on a line command, the line arbiter may issue a group ID command using what was previously a point on a line command. As another example, based on the group ID command, a group arbiter can acquire an entire group of elements at once instead of a single element at once. Thus, a group of elements can be processed simultaneously instead of processing only a single element.

In addition, one or more exemplary embodiments provide a technology that may simultaneously processes, during the same clock cycle, a plurality of groups of elements which have the same line address in one dimensional space, two dimensional space, three-dimensional space, and the like. Thus, by sharing an element reset time and a line address arbitration time occurring in the processing of each group among a plurality of groups on the same line, the overall processing rate may increase because there is less processing delay in comparison to when processing the elements in an individual basis. In addition, by initially processing a common line address and sequentially processing a group address of each group, a size of an address bus may decrease.

Although not limited hereto, in one or more exemplary embodiments, one-dimensional grouping may be easier to implement while a two-dimensional grouping may have better processing performance.

For example, when a plurality of events are generated by a plurality of audio elements, the interface may be configured to simultaneously receive, and the processor may be configured to simultaneously process, the plurality of audio events generated by the plurality of audio elements. As another example, when the plurality of events are generated by a plurality of video elements, and the interface is configured to receive, and the processor is configured to simultaneously process, the plurality of video events generated by the plurality of video elements.

The units described herein may be implemented using hardware components, software components, or a combination thereof. For example, a processing device may be implemented using one or more general-purpose or special purpose computers, such as, for example, a processor, a controller, an arithmetic logic unit, a digital signal processor, a microcomputer, a field programmable array, a programmable logic unit, a microprocessor, any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or semi-permanently in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more non-transitory computer readable recording mediums.

The method according to the exemplary embodiments described herein may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes embodied herein, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An interfacing apparatus comprising:
a grouper configured to generate a group event signal in which a plurality of event generation elements corresponding to a plurality of pixels in at least one event sensor are grouped, based on one or more events occurring with respect to the plurality of pixels; and
an interface configured to output an address of a group of the plurality of event generation elements in which the one or more event occurs, based on the generated group event signal.

2. The interfacing apparatus of claim 1, wherein the event generation elements are respectively configured to generate an event signal asynchronously in response to an occurrence of an event corresponding to a respective event generation element.

3. The interfacing apparatus of claim 1, wherein the address of the group is an address representing the plurality of event generation elements belonging to the group.

4. The interfacing apparatus of claim 1, wherein the grouped plurality of event generation elements are disposed consecutively in a predetermined pattern.

5. The interfacing apparatus of claim 4, wherein the predetermined pattern comprises at least one of:
a pattern in which event generation elements are disposed consecutively in a row direction in a group;
a pattern in which event generation elements are disposed consecutively in a column direction in a group; and
a pattern in which event generation elements are disposed in a form of a matrix of both the row direction and the column direction of in a group.

6. The interfacing apparatus of claim 1, wherein the interface is configured to output an address corresponding to the group event signal, in response to the generated group event signal.

7. The interfacing apparatus of claim 1, wherein the interface is configured to select one of a plurality of generated group event signals and output an address corresponding to the selected group event signal.

8. The interfacing apparatus of claim 1, wherein the interface is configured to further output data of the group of the plurality of elements based on the group event signal.

9. The interfacing apparatus of claim 1, wherein the interface is configured to further output a timestamp that corresponds to a time at which an event occurs, in response to the group event signal.

10. The interfacing apparatus of claim 1, wherein each of the event generation elements comprises at least one of:
a first state corresponding to an occurrence of an event; and
a second state distinct from the first state.

11. The interfacing apparatus of claim 10, wherein the event generation elements are configured to:
be initialized in the second state,
transition to the first state in response to the occurrence of the event, and
transition to the second state in response to a reset signal.

12. The interfacing apparatus of claim 10, wherein the event generation elements are configured to generate an event signal in the first state.

13. The interfacing apparatus of claim 1, wherein the interface comprises:
a first arbiter configured to select one of at least one first group event signal, in response to the at least one first group event signal; and
a second arbiter configured to select one of at least one second group event signal, in response to the at least one second group event signal corresponding to the selected first group event signal.

14. The interfacing apparatus of claim 13, wherein the at least one first group event signal is generated by grouping first event signals corresponding to the event generation elements, and
the at least one second group event signal is generated by grouping second event signals corresponding to the event generation elements.

15. The interfacing apparatus of claim 14, wherein the first event signals are event signals that are output from the event generation elements in a first direction, and
the second event signals are event signals that are output from the event generation elements in a second direction.

16. The interfacing apparatus of claim 13, wherein the first arbiter is configured to output a first address corresponding to the selected first group event signal,
the second arbiter is configured to output a second address corresponding to the selected second group event signal, and
the interface further comprises:
a data output unit configured to output data of a group corresponding to the first address and the second address.

17. The interfacing apparatus of claim 16, wherein the interface further comprises:
a communicator configured to transmit a request signal to control an output of the first address, the second address, and the data, and receive a response signal that is configured to control a read-out of the first address, the second address, and the data.

18. The interfacing apparatus of claim 17, wherein the second arbiter is configured to apply a reset signal to event generation elements corresponding to the second address, in response to the response signal.

19. The interfacing apparatus of claim 1, wherein the interface comprises:
a first arbiter configured to select one group event signal from at least one first group event signal, in response to the at least one first group event signal; and
a second arbiter configured to iteratively select at least two second group event signals from a plurality of second group event signals, in response to the plurality of second group event signals corresponding to the selected first group event signal.

20. The interfacing apparatus of claim 19, wherein the first arbiter is configured to output a first address corresponding to the selected first group event signal, and
the second arbiter is configured to iteratively output second addresses corresponding to the at least two selected plurality of second group event signals.

21. The interfacing apparatus of claim 20, wherein the interface further comprises:
a data output unit configured to output data of a group corresponding to the first address and a currently output second address corresponding to a current second group of event signals among the second addresses corresponding to the at least two of the plurality of second group event signals.

22. The interfacing apparatus of claim 20, wherein the second arbiter is configured to apply a reset signal to event generation elements corresponding to the second addresses after the second addresses are output.

23. The interfacing apparatus of claim 1, further comprising at least one of:
a vision sensor comprising the event generation elements;
an auditory sensor comprising the event generation elements; and
a processing device comprising the event generation elements.

24. A user input processing method comprising:
receiving an address of a group of event generation elements in which an event occurs and data of the group, in response to a user input;
obtaining event information based on the received address of the group, the data of the group, and grouping information of the group; and
processing the user input based on the obtained event information.

25. The user input processing method of claim 24, wherein the group of the event generation elements are disposed consecutively in a predetermined pattern, and
the event generation elements are respectively configured to generate an event signal asynchronously in response to an occurrence of an event.

26. The user input processing method of claim 24, wherein the address of the group comprises an address representing event generation elements belonging to the group.

27. The user input processing method of claim 24, wherein the receiving comprises:
receiving a request signal;
reading out a first address of the group;
reading out a second address of the group;
reading out data of the group; and
transmitting a response signal.

28. The user input processing method of claim 24, wherein the receiving comprises:
receiving a first address common to a plurality of groups; and
iteratively receiving items of data of the plurality of groups and second addresses that distinguish the plurality of groups.

29. The user input processing method of claim 28, wherein the receiving of the first address comprises:
receiving a first request signal;
reading out the first address; and
transmitting a first response signal.

30. The user input processing method of claim 28, wherein the iteratively receiving the items of data of the plurality of groups and second addresses comprises:
receiving a second request signal;
reading out a currently received second address from among the second addresses;
reading out currently received data from among the items of data; and
transmitting a second response signal based on both of the readings.

31. The user input processing method of claim 24, wherein the grouping information comprises:
dimension information of the group; and
information on mapping between a plurality of bits of the data of the group and event generation elements in the group.

32. The user input processing method of claim 24, wherein the obtaining comprises:
calculating reference coordinates corresponding to the address of the group; and
calculating coordinates of at least one pixel in which an event occurs based on the reference coordinates, the data of the group, and the grouping information of the group.

33. A non-transitory computer-readable medium having recorded thereon a computer program that is executable by a computer to perform the method of claim 24.

34. A processing apparatus configured to increase a processing rate of a display apparatus, the processing apparatus comprising:
an interface configured to receive a group of events that occur in the display apparatus, the group of events corresponding to a plurality of event-based elements of the display apparatus which respectively detect one or more events; and
a processor configured to simultaneously process the group of events corresponding to the plurality of event-based elements.

35. The processing apparatus of claim 34, further comprising a grouper configured to generate the group of events by grouping event-based elements of the display apparatus into a plurality of groups,
wherein the group of events is a group selected from among the plurality of groups.

36. The processing apparatus of claim 34, wherein the group of events are generated by a group of video event-based elements, and the interface is configured to receive, and the processor is configured to simultaneously process, the group of events generated by the plurality of video event-based elements.

37. The processing apparatus of claim 34, wherein the group of events are generated by a group of audio event-based elements, and the interface is configured to receive, and the processor is configured to simultaneously process, the group of events generated by the plurality of audio event-based elements.

38. The processing apparatus of claim 34, wherein the group of events correspond to a two-dimensional shape of event-based elements of the display apparatus which detect the one or more events.

39. The processing apparatus of claim 34, wherein at least one event-based element corresponding to the plurality of event-based elements of the display apparatus which detect the one or more events comprise an event-based element which does not detect an occurrence of an event.

40. The processing apparatus of claim 34, wherein the processor is configured to simultaneously process the group of events corresponding to the plurality of event-based elements, during a same clock cycle.
